(19) United States
(12) Patent Application Publication
(10) Pub. No.: US 2026/0030525 A1
(43) Pub. Date: Jan. 29, 2026

(54) AUTOMATED KNOWLEDGE MANAGEMENT FOR A RETRIEVAL-AUGMENTED GENERATION SYSTEM

(71) Applicant: Dropbox, Inc., San Francisco, CA (US)

(72) Inventors: Royce Ausburn, Henley Beach (AU); Bradley Crossen, Redmond, WA (US); Tejas Patel, Austin, TX (US); Eric Cunningham, Kirkland, WA (US)

(21) Appl. No.: 18/780,974

(22) Filed: Jul. 23, 2024

(51) Int. Cl. G06N 5/04

(52) U.S. Cl. CPC G06N 5/04

(57) ABSTRACT

The present disclosure relates to systems, non-transitory computer-readable media, and methods for generating a hybrid prompt for a retrieval augmented generation (RAG) model. In particular, the disclosed systems can generate utilizing a large language model at indexing time for a content item, a topic summary for a topic within the content item. Moreover, the disclosed systems can add the topic summary to a summary knowledge corpus that includes topic summary for a plurality of topics extracted from content items. In one or more cases, at runtime for the RAG model, the disclosed systems can receive prompt language and in response, determine one or more topic summaries that correspond to the prompt language. The disclosed systems can further generate a hybrid prompt by combining the one or more topic summaries with retrieved data accessed by the RAG model in response to the prompt language.

### BACKGROUND

Recent years have seen significant developments in artificial intelligence (AI) software and usage of large language models. Indeed, the increased popularity of large language models and the ever-evolving context of the internet has led to AI, and more specifically large language models, generating, summarizing, translating, and classifying digital content. For example, large language models can perform tasks ranging from summarizing notes to generating images. Based on these capabilities, some existing systems integrate large language models into programming architecture, data analysis pipelines, or other data processing systems. For example, some existing systems utilize retrieval-augmented generators (RAGs) to retrieve information and generate responses to queries. Despite these advances, some existing systems exhibit a number of problems in relation to accuracy and efficiency.

As just mentioned, many existing retrieval-augmented generation systems are inaccurate. Specifically, existing RAGs often generate inaccurate content based on their overgeneralized knowledge base used to train large language models. For example, many existing RAGs depend on an unbiased and complete database that includes vast amounts of data across a huge variety of topics and fields. If the database is incomplete, biased, or lacks quality, the RAG generates inaccurate and irrelevant responses. Moreover, existing RAGs utilize large language models that are trained over enormous databases of common general data to achieve broad coverage of output generation across a wide array of contexts. Unfortunately, a consequence of such wide-ranging and generalized training is that the resulting large language models often hallucinate, generating erroneous, irrelevant, or incorrect responses (or other outputs) that the models treat as true. Without ways to remediate the inaccurate outputs generated by existing large language models, many conventional RAGs produce unreliable outputs, which negatively affect downstream analysis and/or use of such outputs.

In addition to their inaccurate analysis, existing RAGs suffer from inefficiency. More specifically, since some existing RAGs provide inaccurate responses, such existing RAGs unnecessarily utilize computing resources by going back and forth with a client device to generate an accurate and relevant response. Indeed, existing RAGs spend extra computing resources trying to figure out what information is relevant to a user account when generating a response. Indeed, such existing systems do not have contextual knowledge of certain user accounts and thus, cannot generate tailored or relevant outputs. Moreover, in response to a query, some existing RAGs must utilize a slow and resource-intensive process to find and fetch a plurality of data segments from several content items to generate the response. Indeed, the conventional data fetching process sometimes requires (depending on the task) fetching data from many different network locations storing various content items and thus requires existing RAGs to utilize computing-intensive resources to generate responses.

These along with additional problems and issues exist with regard to conventional large language model systems.

### SUMMARY

Embodiments of the present disclosure provide benefits and/or solve one or more of the foregoing or other problems in the art with systems, non-transitory computer readable media, and methods for generating responses specific to an entity by employing pre-processing steps that improve the contextual understanding of a large language model in a RAG by providing extra context, knowledge, and/or data to the large language model during response generation. More specifically, during pre-processing, the disclosed systems utilize the large language model to generate a topic summary to include, along with data retrieved by the RAG, as part of a hybrid prompt. For example, at indexing time, the disclosed systems can receive or access a content item and generate a topic summary for a topic within the content item. In some cases, the disclosed system can add the topic summary to a summary knowledge corpus that also includes topic summaries for a plurality of topics. Additionally, the disclosed systems can maintain and update topics, topic summaries, relationships, etc. in the summary knowledge corpus, so that the disclosed systems can utilize up-to-date and relevant information while generating a hybrid prompt. During runtime for the RAG, the disclosed systems can receive a prompt from a client device and determine if one or more topic summaries in the summary knowledge corpus correspond to the prompt. Additionally, in some cases, in response to the prompt, the disclosed systems can generate a hybrid prompt for the RAG by combining the one or more topic summaries with retrieved data accessed by the RAG.

Additional features and advantages of one or more embodiments of the present disclosure are outlined in the description which follows, and in part can be determined from the description, or may be learned by the practice of such example embodiments.

### BRIEF DESCRIPTION OF THE DRAWINGS

The detailed description provides one or more embodiments with additional specificity and detail through the use of the accompanying drawings, as briefly described below.

FIG. 1 illustrates a diagram of an environment in which a RAG knowledge system can operate in accordance with one or more embodiments.

FIG. 2 illustrates an overview of a RAG knowledge system generating a topic summary utilizing a large language model and generating a hybrid prompt that includes one or more topic summaries in accordance with one or more embodiments.

FIGS. 3A-3C illustrate the RAG knowledge system generating one or more topic summaries and determining one or more topic summaries that correspond with prompt language in accordance with one or more embodiments.

FIG. 4 illustrates the RAG knowledge system determining relationships among content items, topics, and summaries in accordance with one or more embodiments.

FIG. 5 illustrates the RAG knowledge system updating one or more topic summaries or generating a new topic based on a relevance of a new content item in accordance with one or more embodiments.

FIG. 6 illustrates the RAG knowledge system pruning one or more topic summaries in accordance with one or more embodiments.

FIG. 7 illustrates the RAG knowledge system generating a hybrid prompt in accordance with one or more embodiments.

FIG. 8 illustrates an example series of acts for generating a hybrid prompt in accordance with one or more embodiments.

FIG. 9 illustrates a block diagram of an exemplary computing device (e.g., the server(s) and/or the client device) that may be configured to perform one or more of the processes described in accordance with one or more embodiments.

FIG. 10 illustrates a schematic diagram illustrating an exemplary environment within which one or more implementations of the RAG knowledge system can be implemented in accordance with one or more embodiments.

### DETAILED DESCRIPTION

This disclosure describes one or more embodiments of a retrieval augmented generation (RAG) knowledge system that generates a hybrid prompt informed by a summary knowledge corpus to improve generated responses by informing a large language model with contextual background data relevant to a received prompt. In many scenarios, systems utilize retrieval-augmented generators (RAGs) as a basis for generating responses to natural language prompts or queries. Some RAGs are large language models (LLMs) trained on unlabeled and unrelated text from billions (or more) of documents to generate a response to the prompt. Such models rely further on knowledge databases or corpuses of data to access and analyze in conjunction with the prompt to generate responses. As opposed to the generic RAGs of prior systems, the RAG knowledge system described herein employs pre-processing steps to add relevant and contextual information to a prompt so that when the RAG knowledge system receives a prompt or query, the RAG knowledge system can generate a personalized and well-informed response to the prompt.

In some embodiments, the RAG knowledge system generates a hybrid prompt that informs a large language model with additional background and context data from a summary knowledge corpus when generating a response to a prompt. Specifically, the RAG knowledge system generates the hybrid prompt by utilizing a large language model at indexing time to generate a topic summary for a topic within a content item and by adding the topic summary to a summary knowledge corpus that includes topic summaries for a plurality of topics. When the RAG knowledge system receives prompt language from a client device, the RAG knowledge system can determine one or more topics that correspond to the prompt language and combine the one or more topics with retrieved data into the hybrid prompt. The RAG knowledge system can cause a large language model in the RAG model to process the hybrid prompt and generate a targeted and well-informed response.

At an indexing time, the RAG knowledge system can utilize the large language model to generate a topic summary for a topic within a content item. For example, when downloading or ingesting a content item, the RAG knowledge system can utilize the large language model to find a theme, topic, entity, and/or subject within the content item. In one or more embodiments, the RAG knowledge system can generate a topic summary for the theme, topic, entity, and/or subject within the content item.

Moreover, the RAG knowledge system can add the topic summary to a summary knowledge corpus. In some cases, the summary knowledge corpus includes topic summaries for a plurality of topics extracted from content items within a content management system. For example, in one or more embodiments, during previous indexing times, the RAG knowledge system generated topic summaries for one or more topics from the content items stored in the content management system. On top of storing topic summaries, the summary knowledge corpus can include relationship descriptions defining relationships among the plurality of topics. For example, the summary knowledge corpus can include relationship descriptions indicating strong relationships among one or more topics or weak relationships among one or more topics. Moreover, the RAG knowledge system can maintain and update the summary knowledge corpus. For example, the RAG knowledge system can edit topics, topic summaries, and various relationships. To further illustrate, the RAG knowledge system can utilize a large language model to add and/or remove context to topic summaries and/or topics. In some cases, the RAG knowledge system can add relationships to topics and/or topic summaries by linking topics and/or topic summaries to entities, other topics, and/or other topic summaries.

In one or more implementations, at a runtime for a retrieval augmented generation (RAG) model, the RAG knowledge system can receive prompt language from a client device defining a task. Based on the prompt language, the RAG knowledge system can determine if one or more topics from the summary knowledge corpus correspond to the prompt language. Indeed, the RAG knowledge system can compare the prompt language with one or more topic summaries and determine the relevance of one or more topic summaries in regard to the prompt language. In one or more embodiments, based on the relevance, the RAG knowledge system can generate a hybrid prompt for the RAG model by combining one or more topic summaries that correspond to the prompt language with retrieved data accessed by the RAG model in response to the prompt language. In one or more implementations, the RAG knowledge system can input the hybrid prompt into a large language model of the RAG model to generate an accurate and well-informed response.

The RAG knowledge system provides a variety of technological advantages relative to conventional systems. For example, the RAG knowledge system can improve the accuracy of generating responses to queries utilizing RAGs and/or large language models. Specifically, while prior systems are sometimes overly reliant on large language models that are trained on generalized data, the RAG knowledge system inputs data specifically relevant to (and stored for) an entity into the large language model of the RAG model. As opposed to existing systems whose models are prone to hallucination, especially when facing domain shifts, the RAG knowledge system can accommodate for gaps between training data and content items associated with an entity by enhancing prompts with topic summaries that are relevant to the prompt and/or the entity that generated the prompt. Indeed, by providing increased direction and context to the large language model when generating a response, the RAG knowledge system improves the accuracy of responses.

Additionally, the RAG knowledge system provides improved efficiency over conventional systems. For example, unlike existing systems that require several back-and-forth interactions to hone in on all of the relevant information related to a prompt, the RAG knowledge system can utilize topic summaries from a plurality of topics to generate a well-informed response in response to receiving a single prompt. Indeed, unlike existing systems that waste computational resources, the RAG knowledge system can generate an accurate response without requiring several back-and-forth prompts and responses.

Moreover, unlike existing systems that search and retrieve data segments only for content items relating to the query in response to the prompt, the RAG knowledge system generates a knowledge corpus from topic summaries. Indeed, the RAG knowledge system generates a corpus of summaries of content items at indexing time to reduce the compute costs and processing speed of generating a response to the prompt. Thus, during an indexing time, the RAG knowledge system can generate one or more topic summaries from content items that are likely to be retrieved by the RAG knowledge system during response generation. Such pre-processing by the RAG knowledge system tees up the RAG knowledge system for quick and efficient retrieval of content items during response generation by utilizing the topic summaries as a knowledge base for retrieval in response to a query or prompt.

As illustrated by the foregoing discussion, the present disclosure utilizes a variety of terms to describe features and advantages of the RAG knowledge system. Additional detail is now provided regarding the meaning of such terms. For example, as used herein, the term “digital content item” (or simply “content item”) refers to a digital object or a digital file that includes information interpretable by a computing device (e.g., a client device) to present information to a user. A digital content item can include a file or a folder such as a digital text file, a digital image file, a digital audio file, a webpage, a website, a digital video file, a web file, a link, a digital document file, or some other type of file or digital object. A digital content item can have a particular file type or file format, which may differ for different types of digital content items (e.g., digital documents, digital images, digital videos, or digital audio files). In some cases, a digital content item can refer to a remotely stored (e.g., cloud-based) item or a link (e.g., a link or reference to a cloud-based item or a web-based content item) and/or a content clip that indicates (or links/references) a discrete selection or segmented sub-portion of content from a webpage or some other content item or source. A content item can also include application-specific content that is siloed to a particular computer application but is not necessarily accessible via a file system or via a network connection. A digital content item can be editable or otherwise modifiable and can also be sharable from one user account (or client device) to another. In some cases, a digital content item is modifiable by multiple user accounts (or client devices) simultaneously and/or at different times. In one or more implementations a digital content item can correspond to a specific entity, organization, group, user account, and/or individual.

As used herein, the term “indexing time” refers to a time or period of time of indexing content items. For instance, indexing time can include or refer to a time of ingesting, processing, and/or receiving a content item in a content management system. In some embodiments, indexing time is distinct from runtime in that indexing time is a pre-processing time period of preparing data for analysis at runtime. For example, an indexing time can occur when the RAG knowledge system detects the presence and/or upload of a content item in the content management system. In some cases, the indexing time can occur iteratively. For instance, an indexing time could occur daily, weekly, or monthly.

Relatedly, as used herein, the term “runtime” refers to a time or period of time when a RAG model generates a response to a prompt and/or query. For example, a runtime can commence when the RAG knowledge system utilizes the RAG model to generate a response to a prompt. In some cases, runtime refers to a time (after indexing time) where the RAG knowledge system analyzes or processes data prepared at indexing time (e.g., within a summary knowledge corpus).

As used herein, the term “topic summary” refers to a summary of a topic, subject, entity, or theme. For example, a topic summary can include words, sentences, and/or paragraphs describing the topic. In some cases, the RAG knowledge system utilizes a large language model to generate the topic summary. Indeed, topic summaries can have varying lengths providing more detail or less detail about the topic. For example, a topic summary relating to a project can include the goals of the project, important deadlines, and/or key players involved in the project. In some cases, a topic summary can include references to other topic summaries or relationships to other topics.

Relatedly, as used herein, the term “topic” refers to a subject, entity, project, collection of content items, theme, or issue. For example, a topic can be, but is not limited to, a project, person, organization, event, date, bylaws, goal, work product, sales, revenue, assets, strategy, finances, or proposals. In some cases, a topic can be extracted from one or more content items in a content management system. To illustrate, the RAG knowledge system can extract a topic regarding total sales for a given month by extracting sales data from one or more sales reports for the given month. In one or more cases, a topic can correspond to one or more topic summaries describing aspects of the topic.

Additionally, as used herein, the term “summary knowledge corpus” refers to a collection of topic summaries for a plurality of topics. In some cases, the summary knowledge corpus can also house descriptions for relationships among the plurality of topics, relationship summaries for relationships among entities and the plurality of topics, relationships among the content items and the plurality of topics, and/or relationships among the content items and the entities. In some cases, the summary knowledge corpus includes multiple summaries per topic, where each of the topic-specific summaries may have a different length and/or level of detail.

Moreover, as used herein, the term “retrieval augmented generation model” (or “RAG” or “RAG model”) refers to a natural language processing structure and/or software with one or more components that generate a response to a prompt based on data retrieval. For example, a RAG model can include a natural language processing structure and a data retrieval structure that determines data to access from a corpus to use, in conjunction with prompt language, as the basis for generating a response. In some cases, the RAG model can include an embedding model, a vector database, and a large language model. To further illustrate, the embedding model can generate embeddings for received queries and one or more content items. For instance, the embedding model can generate vectorized segments for the content items. In some cases, the vector database can store the embeddings of content items. For example, the vector database can house vectorized segments of one or more content items. In one or more implementations, the RAG model can retrieve data contexts from the vector database by comparing the query embeddings with the content item embeddings. Moreover, the RAG knowledge system can cause the RAG model to input the query and the retrieved data into the large language model to generate a response.

Further, as used herein, the term “large language model” refers to a machine learning model trained to perform computer tasks to generate or identify content items in response to trigger events (e.g., user interactions, such as text queries, prompts, and/or button selections). In particular, a large language model can be a neural network (e.g., a deep neural network) with many parameters trained on large quantities of data (e.g., unlabeled text) using a particular learning technique (e.g., self-supervised learning). For example, a large language model can include parameters trained to generate model outputs (e.g., content items, summaries, or query responses) and/or to identify content items based on various contextual data, including graph information from a knowledge graph and/or historical user account behavior. In some cases, a large language model comprises a GPT model such as, but not limited to, ChatGPT.

Relatedly, as used herein, the term “machine learning model” refers to a computer algorithm or a collection of computer algorithms that automatically improve for a particular task through iterative outputs or predictions based on the use of data. For example, a machine learning model can utilize one or more learning techniques to improve accuracy and/or effectiveness. Example machine learning models include various types of neural networks, decision trees, support vector machines, linear regression models, and Bayesian networks. In some embodiments, the morphing interface system utilizes a large language machine-learning model in the form of a neural network.

Along these lines, the term “neural network” refers to a machine learning model that can be trained and/or tuned based on inputs to determine classifications, scores, or approximate unknown functions. For example, a neural network includes a model of interconnected artificial neurons (e.g., organized in layers) that communicate and learn to approximate complex functions and generate outputs (e.g., content items or summaries) based on a plurality of inputs provided to the neural network. In some cases, a neural network refers to an algorithm (or set of algorithms) that implements deep learning techniques to model high-level abstractions in data. A neural network can include various layers, such as an input layer, one or more hidden layers, and an output layer that each perform tasks for processing data. For example, a neural network can include a deep neural network, a convolutional neural network, a transformer neural network, a recurrent neural network (e.g., an LSTM), a graph neural network, or a generative adversarial neural network. Upon training, such a neural network may become a large language model.

Moreover, as used herein, the term “hybrid prompt” refers to a prompt augmented with contextual information, data, and/or background from one or more content items. In particular, along with prompt language from a client device, a hybrid prompt can include one or more topic summaries extracted from one or more content items and retrieved data accessed by the RAG model. For example, in some cases, the hybrid prompt can include one or more topic summaries about a project combined with relationships among the topics related to the topic summaries. In some cases, the hybrid prompt can include the prompt language from the received prompt, along with one or more topic summaries and/or data from one or more content items.

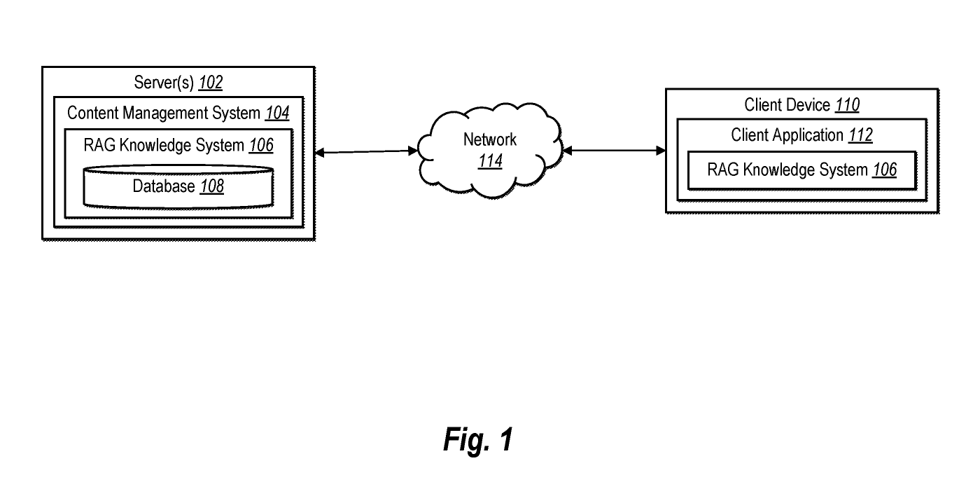

Additional detail regarding the RAG knowledge system will now be provided with reference to the figures. For example, FIG. 1 illustrates a schematic diagram of an example system environment for implementing a RAG knowledge system 106 in accordance with one or more embodiments. An overview of the RAG knowledge system 106 is described in relation to FIG. 1. Thereafter, a more detailed description of the components and processes of the RAG knowledge system 106 is provided in relation to the subsequent figures.

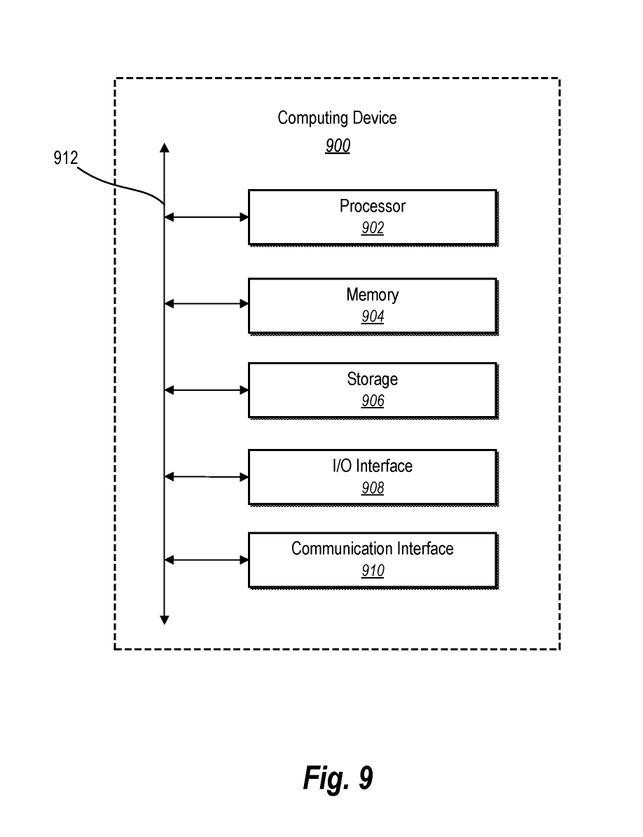

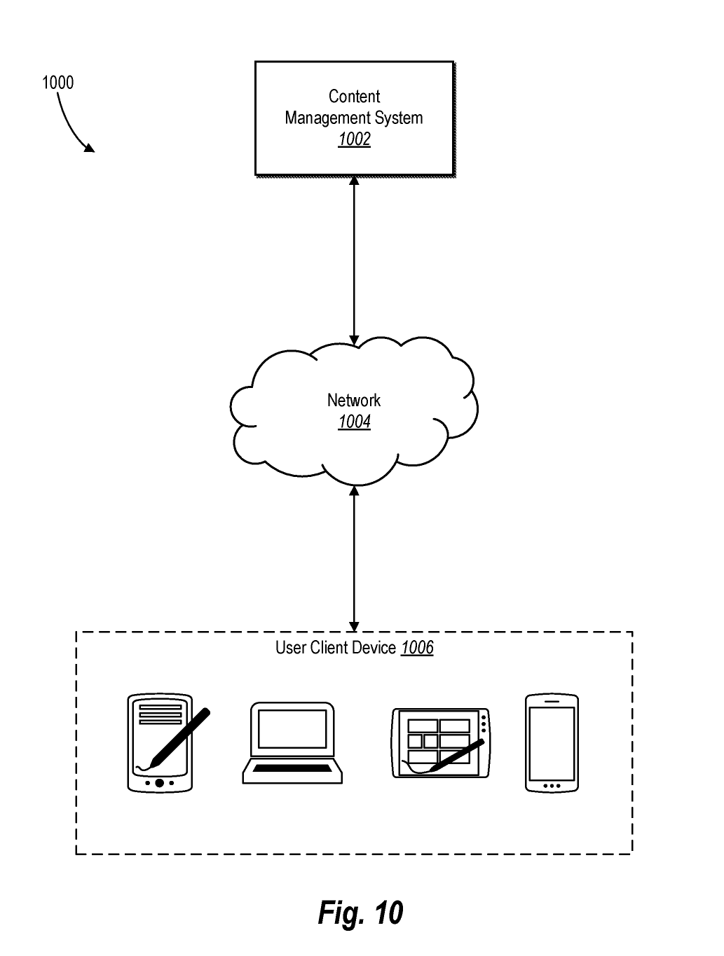

As shown, the environment includes server(s) 102, a client device 110, and a network 114. Each of the components of the environment can communicate via the network 114, and the network 114 may be any suitable network over which computing devices can communicate. Example networks are discussed in more detail below in relation to FIGS. 9-10.

As mentioned above, the example environment includes client device 110. The client device 110 can be one of a variety of computing devices, including a smartphone, a tablet, a smart television, a desktop computer, a laptop computer, a virtual reality device, an augmented reality device, or another computing device as described in relation to FIGS. 9-10. The client device 110 can communicate with the server(s) 102 and/or the database 108 via the network 114. For example, the client device 110 can receive user input from a user interacting with the client device 110 (e.g., via the client application 112) to, for instance, access, generate, modify, or share a content item, to collaborate with a co-user of a different client device, or to select a user interface element. In some cases, the client device 110 can receive input for a query or prompt. In addition, the RAG knowledge system 106 on the server(s) 102 can receive information relating to various interactions with content items and/or user interface elements based on the input received by the client device 110 (e.g., to access content items, input a query, or perform some other action).

As shown, the client device 110 can include a client application 112. In particular, the client application 112 may be a web application, a native application installed on the client device 110 (e.g., a mobile application, a desktop application, etc.), or a cloud-based application where all or part of the functionality is performed by the server(s) 102. Based on instructions from the client application 112, the client device 110 can present or display information, including a user interface for inputting prompts or queries into a RAG model and/or large language model, displaying a response from the RAG model and/or large language model, or content items from the content management system 104 or from other network locations.

As illustrated in FIG. 1, the example environment also includes the server(s) 102. The server(s) 102 may generate, track, store, process, receive, and transmit electronic data, such as content items, topic summaries, text segments, embeddings of content items, prompts, prompt language, data contexts, interface elements, interactions with content items, interactions with responses, interactions with interface elements, and/or interactions between user accounts or client devices. For example, the server(s) 102 may receive data from the client device 110 in the form of a prompt requesting the performance of a task. For example, in some cases, the server(s) 102 may receive user input requesting information about a project or a company. In addition, the server(s) 102 can transmit data to the client device 110 in the form of a response that utilizes a hybrid prompt to provide additional context to a large language model. Indeed, the server(s) 102 can communicate with the client device 110 to send and/or receive data via the network 114. In some implementations, the server(s) 102 comprise(s) a distributed server where the server(s) 102 include(s) a number of server devices distributed across the network 114 and located in different physical locations. The server(s) 102 can comprise one or more content servers, application servers, communication servers, web-hosting servers, machine learning server, and other types of servers.

As shown in FIG. 1, the server(s) 102 can also include the RAG knowledge system 106 and the database 108 as part of a content management system 104. The content management system 104 can communicate with the client device 110 to perform various functions associated with the client application 112 such as managing user accounts, embedding queries, generating topic summaries, managing a plurality of topics and/or topic summaries in a summary knowledge corpus, managing a repository of content item embeddings (e.g., vectorized content items) and vectorized segments of content items, and facilitating user interaction with the content items. Indeed, the content management system 104 can include a network-based smart cloud storage system to manage, store, and maintain content items and related data across numerous entities, groups, and/or user accounts, including user accounts in collaboration with one another. In some embodiments, the RAG knowledge system 106 and/or the content management system 104 utilize the database 108 to store and access information such as content items, topic summaries, topics, relationships, content item embeddings, vectorized content items, etc. For example, in some cases, the database 108 houses both the summary knowledge corpus and the content items.

Although FIG. 1 depicts the RAG knowledge system 106 located on the server(s) 102, in some implementations, the RAG knowledge system 106 may be implemented by (e.g., located entirely or in part on) one or more other components of the environment. For example, the RAG knowledge system 106 may be implemented by the client device 110. For example, the client device 110 can download all or part of the RAG knowledge system 106 for implementation independent of, or together with, the server(s) 102.

In some implementations, though not illustrated in FIG. 1, the environment may have a different arrangement of components and/or may have a different number or set of components altogether. For example, the client device 110 may communicate directly with the RAG knowledge system 106, bypassing the network 114. As another example, the environment can include the database 108 located external to the server(s) 102 (e.g., in communication via the network 114), located on the server(s) 102 as illustrated in FIG. 1, and/or on the client device 110.

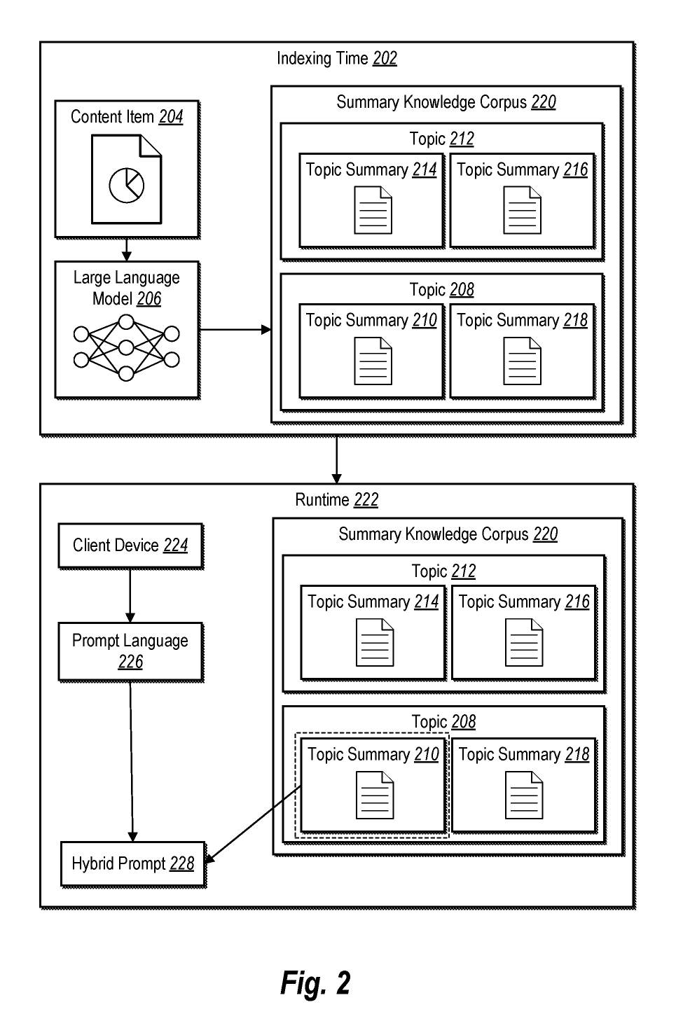

As mentioned above, in certain embodiments, the RAG knowledge system 106 can improve a response to a prompt by generating a hybrid prompt that provides contextual information to a large language model during response generation. For example, during an indexing time, the RAG knowledge system 106 can generate one or more topic summaries from a content item and add the one or more topic summaries to a summary knowledge corpus. Moreover, during runtime, the RAG knowledge system 106 can determine if one or more topic summaries correspond to prompt language (e.g., language used in a prompt or query) and combine one or more corresponding topic summaries with retrieved data to generate a hybrid prompt that informs the large language model with additional, relevant information while generating a response. FIG. 2 illustrates an overview of a RAG knowledge system 106 generating a topic summary utilizing a large language model and generating a hybrid prompt that includes one or more topic summaries in accordance with one or more embodiments.

As shown in FIG. 2, at an indexing time 202, the RAG knowledge system 106 can process and/or ingest a content item 204. In one or more embodiments, the RAG knowledge system 106 can processes the content item 204 by inputting the content item 204 into a large language model 206 to identify one or more topics 208, 212 within the content item 204. As further shown in FIG. 2, the RAG knowledge system 106 can further utilize the large language model 206 to generate a topic summary 210 for a topic 208 extracted from the content item 204.

As FIG. 2 illustrates, in some cases, the RAG knowledge system 106 can add the topic summary 210 extracted from the content item 204 to a topic 208 in a summary knowledge corpus 220. In some embodiments, the summary knowledge corpus 220 can include a plurality of topics 208, 212 that correspond to a plurality of topic summaries 210, 214, 216, 218. For example, the summary knowledge corpus 220 can include a topic 212 with topic summaries 214, 216 that differs from topic 208 that corresponds to topic summaries 210, 218. In some cases, the RAG knowledge system 106 can monitor, edit, maintain, and/or prune the topics 208, 212 and/or topic summaries 210, 214, 216, 218 in the summary knowledge corpus 220 so that the summary knowledge corpus 220 is relevant and up-to-date. For example, based on adding one or more new content items to the content management system, the RAG knowledge system 106 can utilize the large language model 206 to tweak and/or edit the one or more topic summaries 214, 216, 218 by adding content from the one or more new content items to the one or more topic summaries 214, 216, 218 and/or removing existing content from the one or more topic summaries 214, 216, 218. In some cases, the RAG knowledge system 106 can update the length of the one or more topic summaries 214, 216, 218. Moreover, the RAG knowledge system 106 can modify and/or update the relationships among topics, topic summaries, entities, and content items. For example, based on a change in leadership of the entity, the RAG knowledge system 106 can change relationships (e.g., links) among one or more topics, one or more topic summaries 214, 216, 218, and/or one or more entities.

As further shown in FIG. 2, at a runtime 222 for a RAG model, the RAG knowledge system 106 can receive a prompt with prompt language 226 from a client device 224. In response to the prompt language 226 during the runtime 222, the RAG knowledge system 106 can access the summary knowledge corpus 220 and determine if one or more topic summaries 210, 214, 216, 218 corresponds to the prompt language 226. In particular, the RAG knowledge system 106 can compare the prompt language 226 with the one or more topic summaries 210, 214, 216, 218 and determine the relevance, via a relevance score, of the one or more topic summaries 210, 214, 216, 218 in relation to the prompt language 226.

As FIG. 2 illustrates, the RAG knowledge system 106 can include one or more topic summaries 210, 214, 216, 218 in the hybrid prompt 228. For example, as shown in FIG. 2, based on the topic summary 210 corresponding to the prompt language 226, the RAG knowledge system 106 can include the topic summary 210 with retrieved data in the hybrid prompt 228. In one or more embodiments, the RAG knowledge system 106 can utilize an additional large language model, neural network, and/or decision tree to generate the hybrid prompt 228 based on ranking and/or scoring the relevance of the topics and/or topic summaries 210, 214, 216, 218. Additionally, in one or more embodiments, the RAG knowledge system 106 can provide the hybrid prompt 228 to a large language model in a RAG model to generate an informed response to the prompt.

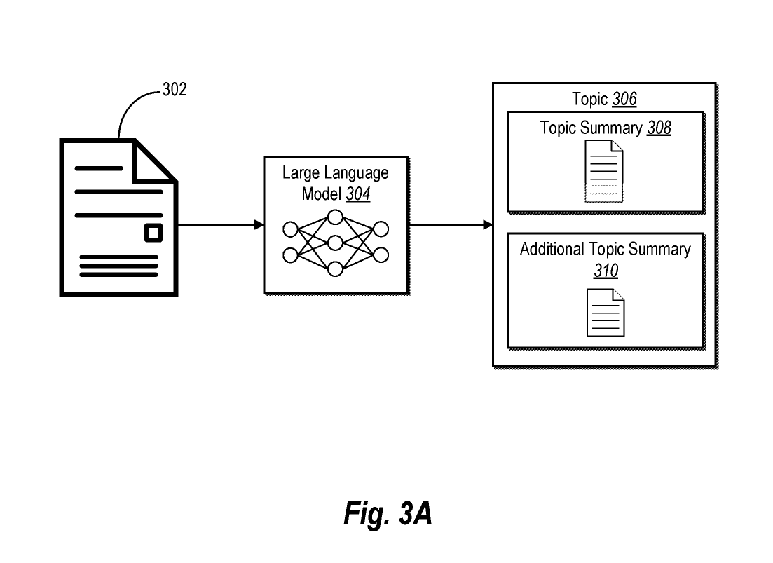

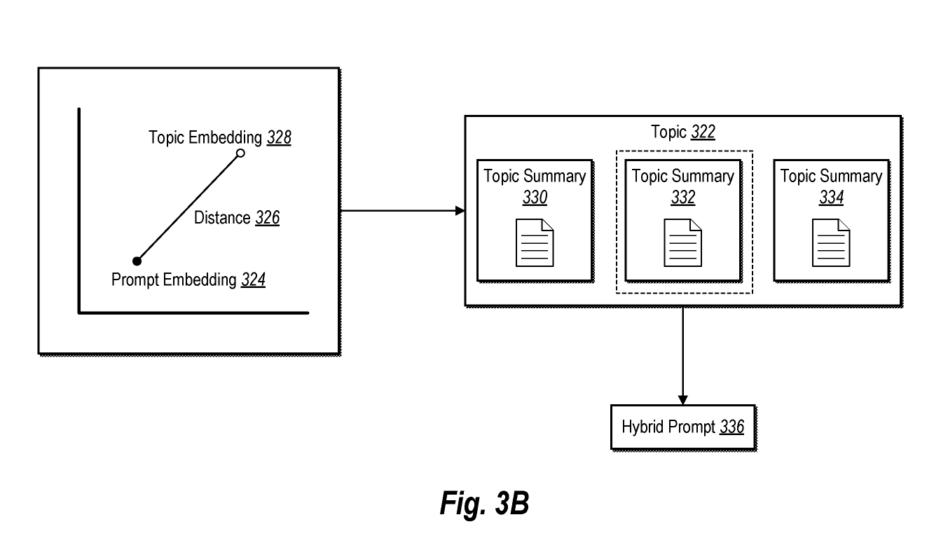

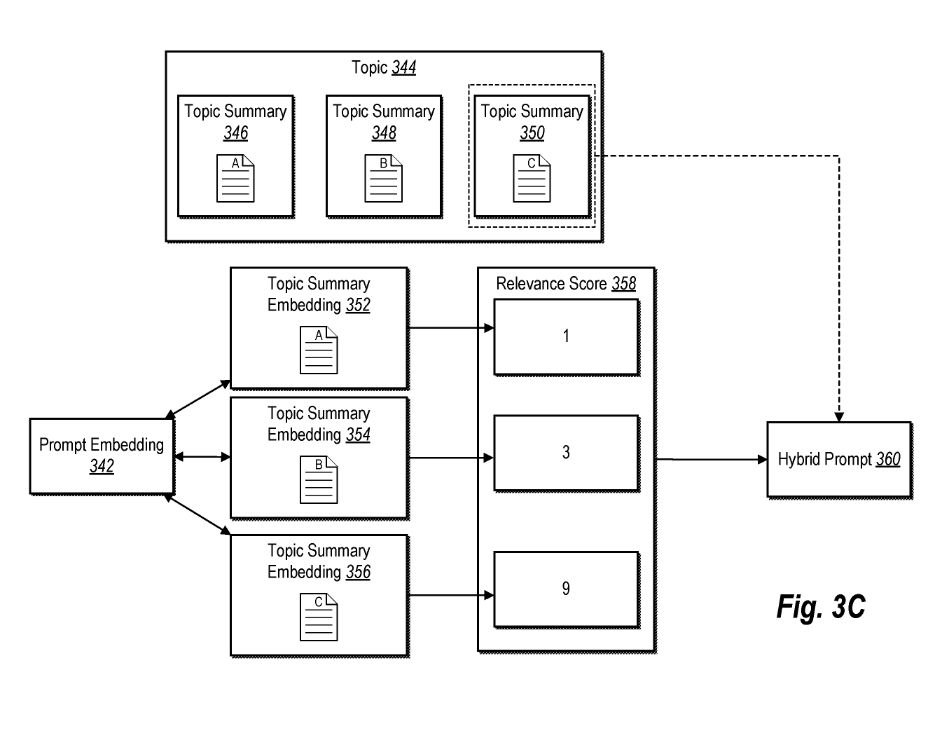

As noted above, in certain embodiments, the RAG knowledge system 106 can generate one or more topic summaries for a topic extracted from a content source item. In particular, the RAG knowledge system 106 can utilize a large language model to extract a topic from the content item and generate a topic summary for the topic. FIGS. 3A-3C illustrate the RAG knowledge system 106 generating one or more topic summaries and determining that one or more topic summaries correspond to a prompt in accordance with one or more embodiments. In particular, FIG. 3A illustrates the RAG knowledge system 106 generating one or more topic summaries for a topic within a content item in accordance with one or more embodiments. Thereafter, FIG. 3B illustrates the RAG knowledge system 106 selecting a topic summary with a determined length to include in the hybrid prompt, and FIG. 3C illustrates the RAG knowledge system 106 selecting a topic summary to include in the hybrid prompt based on a relevance score in accordance with one or more embodiments.

As shown in FIG. 3A, the RAG knowledge system 106 can process a content item 302 at an indexing time. For example, as the RAG knowledge system 106 ingests the content item 302, the RAG knowledge system 106 can utilize a large language model 304 to identify and/or extract a topic 306 from the content item 302. For example, the RAG knowledge system 106 can cause the large language model 304 to scan the content item 302 for topics, themes, subjects, and/or entities. In particular, the large language model 304 can utilize a semantic search or lexical search to identify themes, subjects, entities, and/or concepts within the content item 302. In some embodiments, the RAG knowledge system 106 can further cause the large language model 304 to generate a topic summary 308 for the topic 306. In some implementations, the RAG knowledge system 106 can identify a topic and/or generate a topic summary from one or more content items. For example, in some cases, the RAG knowledge system 106 can receive a dataset with a plurality of files about a new project. The RAG knowledge system 106 can utilize a large language model 304 to generate a topic about the new project and one or more topic summaries based on the plurality of files in the dataset.

As just mentioned, the RAG knowledge system 106 can utilize the large language model 304 to generate the topic summary 308. Moreover, in one or more embodiments, the RAG knowledge system 106 can generate an additional topic summary 310 with a length that differs from the length of the topic summary 308. In one or more cases, the length of the topic summary 308 and/or additional topic summary 310 can correspond to the number of words, letters, tokens, and/or characters. For example, in one or more cases, the length of the topic summary 308 can be 10 words while the length of the additional topic summary 310 can be 10,000 words (or some other length of greater detail than the first length). Indeed, the RAG knowledge system 106 can generate the topic summary 308 for the topic 306 at a first length and an additional topic summary 310 for the topic 306 at a second length (and can generate additional topic summaries at additional lengths). As indicated in FIG. 3A, the second length of the additional topic summary 310 can be shorter than the first length of the topic summary 308. In other words, in one or more cases, the first length of the topic summary 308 can have fewer words, letters, and/or characters than the second length of the additional topic summary 310. As described in more detail below in reference to FIG. 3B, in some cases, the RAG knowledge system 106 can utilize the large language model 304 to determine the length of the topic summary 308 and/or the additional topic summary 310. In alternative embodiments, the RAG knowledge system 106 can utilize a context building algorithm to determine the length and/or level of detail to include in the topic summary 308 and the hybrid prompt.

In one or more embodiments, the RAG knowledge system 106 can store the topic summary 308 and the additional topic summary 310 in the summary knowledge corpus. Indeed, in one or more implementations, the RAG knowledge system 106 can generate a plurality of topic summaries for the topic 306 at varying lengths. For example, in one or more embodiments, based on the focus, usage, and/or size of the topic 306, the RAG knowledge system 106 can generate several topic summaries at varying lengths for the topic 306.

In some cases, during the indexing time, the RAG knowledge system 106 can utilize the large language model 304 to determine the length of one or more topic summaries. For example, the RAG knowledge system 106 can instruct the large language model 304 to generate a longer topic summary based on prompt language being directed towards a single topic. For example, the RAG knowledge system 106 can cause the large language model 304 to generate a long topic summary about “Project Leo” in response to a potential prompt asking for a detailed analysis of Project Leo. Additionally, the RAG knowledge system 106 can instruct the large language model 304 to generate shorter topic summaries based on the potential prompt language requesting information about several topics. For instance, the RAG knowledge system 106 can cause the large language model 304 to generate several short topics summaries about several ongoing projects in response to the potential prompt requesting an overview of current projects for an organization.

In addition to generating one or more topic summaries for the topic 306, the RAG knowledge system 106 can monitor and update the topic summaries for the plurality of topics. In particular, the RAG knowledge system 106 can utilize an additional large language model to determine if and when to update, modify, and/or edit one or more topic summaries in the summary knowledge corpus. For example, based on changes to the entity and/or receiving new content items, the RAG knowledge system 106 can update the length and/or content of one or more topic summaries by utilizing the additional large language model.

As previously described, the RAG knowledge system 106 can generate one or more topic summaries with varying lengths. In some embodiments, based on the received prompt language, the RAG knowledge system 106 can determine which topic summary to include in a hybrid prompt. For example, based on comparing the prompt language with the topic, the RAG knowledge system 106 can determine the length for a topic summary of the topic and include the topic summary in the hybrid prompt. FIG. 3B illustrates the RAG knowledge system 106 selecting a topic summary to include in the hybrid prompt in accordance with one or more embodiments.

As shown in FIG. 3B, in one or more embodiments, the RAG knowledge system 106 can compare prompt language from the prompt with a topic 322 within the summary knowledge corpus. As FIG. 3B illustrates, in some cases, the RAG knowledge system 106 can generate a prompt embedding 324 for the prompt language and a topic embedding 328 for the topic 322. For example, the RAG knowledge system 106 can utilize an embedding model to generate the prompt embedding 324 and/or the topic embedding 328. In one or more implementations, the RAG knowledge system 106 can utilize and/or select different embedding models to generate one or more embeddings for the prompt language and the topic 322. Additionally, in some cases, the RAG knowledge system 106 can utilize the embedding model to further generate topic summary embeddings, relationship description embeddings, relationship summary embeddings, etc.

As further shown in FIG. 3B, the RAG knowledge system 106 can determine a distance 326 between the prompt embedding 324 and the topic embedding 328. For example, in one or more embodiments, the RAG knowledge system 106 can determine the distance 326 by determining a cosine similarity, cosine distance, Euclidean distance, or dot product between the prompt embedding 324 and the topic embedding 328 in a continuous space. To further illustrate, in one or more embodiments, the prompt embedding 324 can include one or more vectorized segments of the prompt language and the topic embedding 328 can comprise one or more vectorized segments of the topic 322. In some cases, the RAG knowledge system 106 can determine the cosine similarity between the vectorized segments of the prompt language and the vectorized segments of the topic 322.

As further shown in FIG. 3B, the RAG knowledge system 106 can determine a length of the topic summary 330, 332, 334 based on the distance 326 between the prompt embedding 324 and the topic embedding 328. For example, the distance 326 can indicate the importance and/or relatedness between the prompt language and the topic 322.

For example, in one or more cases, a shorter distance can correspond to more importance of the topic 322 in relation to the prompt and/or prompt language. Additionally, in some embodiments, a longer distance can indicate less importance of the topic 322 in relation to the prompt and/or prompt language. Moreover, in some cases, based on the importance of the topic, the RAG knowledge system 106 can select the topic summary 330, 332, 334 with a certain length to include in the hybrid prompt 336. For instance, as shown in FIG. 3B, the distance 326 between the prompt embedding 324 and the topic embedding 328 can indicate some degree of importance of the topic 322 in relation to the prompt language and based on the degree importance, the RAG knowledge system 106 can select the topic summary 332 that is shorter than the topic summary 330 and longer than the topic summary 334 to include in the hybrid prompt 336. To further illustrate, in one or more cases, the RAG knowledge system 106 can select a topic summary 330 that has a longer length based on a short distance indicating the high importance of the topic 322 in relation to the prompt and/or prompt language. Alternatively, the RAG knowledge system 106 can select a short summary like topic summary 334 based on a long distance indicating the low rank and/or low importance of the topic 322 in relation to the prompt and/or prompt language.

In one or more embodiments, the RAG knowledge system 106 can compare the prompt language with a plurality of topics in the summary knowledge corpus. Indeed, in one or more embodiments, the RAG knowledge system 106 can generate one or more embeddings of the prompt language and one or more embeddings of the plurality of topics (e.g., topic embeddings). In some cases, the RAG knowledge system 106 can compare the one or more prompt embeddings with one or more topic embeddings within a three-dimensional space. For example, in some cases, the RAG knowledge system 106 can compare one or more prompt embeddings with hundreds or thousands of topic embeddings and determine distances among the one or more prompt embeddings and the hundreds or thousands of topic embeddings. Indeed, in one or more embodiments, the RAG knowledge system 106 can include multiple topic summaries, each with varying lengths, from the plurality of topics in the hybrid prompt 336. For example, based on the distances of the topic embeddings for the plurality of topics from the prompt embedding, the RAG knowledge system 106 can determine the length of multiple topic summaries from the plurality of topic summaries and include multiple topic summaries in the hybrid prompt at the determined length. As discussed above, based on the distances, the RAG knowledge system 106 can identify which topics align with prompt and/or determine the length of one or more topic summaries to include in the hybrid prompt.

Additionally, in one or more embodiments, the RAG knowledge system 106 can utilize a large language model to determine which topic summaries and/or topics to include in the hybrid prompt. For example, based on the prompt language and the one or more topic summaries 330, 332, 334, the RAG knowledge system 106 can instruct the large language model to select which topic summary 332, 332, 334 to include in the hybrid prompt 336. In some embodiments, the RAG knowledge system 106 can utilize other methods to select the topic summaries 330, 332, 334 and/or length of the topic summaries 330, 332, 334 to include in the hybrid prompt 336. For example, the RAG knowledge system 106 can utilize a neural network, decision tree, etc. to compare the prompt language with one or more topics and determine which topic summary 330, 332, 334 to include in the hybrid prompt 336.

As mentioned above, the RAG knowledge system 106 can generate one or more embeddings for a prompt and/or a topic. In some instances, the RAG knowledge system 106 can further generate one or more embeddings for topic summaries. FIG. 3C illustrates the RAG knowledge system 106 selecting a topic summary to include in a hybrid prompt in accordance with one or more embodiments.

As shown in FIG. 3C, the RAG knowledge system 106 can generate one or more topic summaries 346, 348, 350 for a topic 344. As described above in FIG. 3B, in one or more implementations, the RAG knowledge system 106 can generate a prompt embedding 342 by utilizing an embedding model. Moreover, as indicated in FIG. 3C, the RAG knowledge system 106 can generate topic summary embeddings 352, 354, 356 for topic summaries 346, 348, 350 by utilizing the embedding model.

As shown in FIG. 3C, the RAG knowledge system 106 can determine if one or more topic summaries 346, 348, 350 correspond to the prompt language associated with the prompt embedding 342 by determining a relevance score 358 for the topic summary 346, 348, 350. For instance, in one or more cases, the RAG knowledge system 106 can determine the relevance score 358 for the one or more topic summaries 346, 348, 350 by comparing, as described above in FIG. 3B, the prompt embedding 342 to the topic summary embeddings 352, 354, 356 that correspond to the topic summaries 346, 348, 350. For instance, as shown in FIG. 3C, the topic summary 346 corresponds to the topic summary embedding 352, the topic summary 348 corresponds to the topic summary embedding 354, and the topic summary 350 corresponds to the topic summary embedding 356. In one or more embodiments, the RAG knowledge system 106 can determine the relevance score 358 based on a cosine distance, cosine similarity, Euclidian distance, or dot product among the prompt embedding 342 and the topic summary embeddings 352, 354, 356.

As further shown in FIG. 3C, based on the relevance score 358, the RAG knowledge system 106 can select the one or more topic summaries 346, 346, 350 to include in the hybrid prompt 360. For example, the relevance score 358 of the topic summary 350 that corresponds to the topic summary embedding 356 is highly relevant to the prompt and/or prompt language. Indeed, as shown in FIG. 3C, based on the high relevance score 358 of the topic summary 350, the RAG knowledge system 106 can include the topic summary 350 in the hybrid prompt 360. In some cases, the RAG knowledge system 106 can determine a relevance score threshold and include one or more topic summaries that match and/or exceed the relevance score threshold.

Moreover, in some embodiments, the RAG knowledge system 106 can include one or more topic summaries according to different parameters. For example, the RAG knowledge system 106 can compare the prompt embedding 342 to thousands or tens of thousands of topic summary embeddings. In some cases, the RAG knowledge system 106 can identify the top 10, 20, or 50 most relevant topic summaries to include in the hybrid prompt 360. In some cases, the RAG knowledge system 106 can further determine the length of the 10 most relevant topic summaries by utilizing a large language model. For example, the RAG knowledge system 106 can instruct the large language model to determine the length for the 10 most relevant topic summaries that will be included in the hybrid prompt 360.

As discussed above, the RAG knowledge system 106 can include one or more topic summaries 346, 348, 350 in the hybrid prompt 360 by comparing the topic 344 and/or topic summaries 346, 348, 350 with the prompt language. In some cases, the RAG knowledge system 106 can receive additional prompt language from the client device and include one or more additional topic summaries in the hybrid prompt 360. For example, as described above, the RAG knowledge system 106 can utilize a large language model to generate the topic summaries 346, 348, 350 with different lengths. To further illustrate, the RAG knowledge system 106 can generate for the topic 344 a first topic summary corresponding to a first length and a second topic summary corresponding to a second length. In some cases, based on receiving the additional prompt language, the RAG knowledge system 106 can include the second topic summary in the hybrid prompt 360. In particular, the RAG knowledge system 106 can compare an additional prompt embedding with a second topic summary embedding. As described above, based on the comparison between the additional prompt embedding and the second topic summary embedding, the RAG knowledge system 106 can include the second topic summary in the hybrid prompt 360.

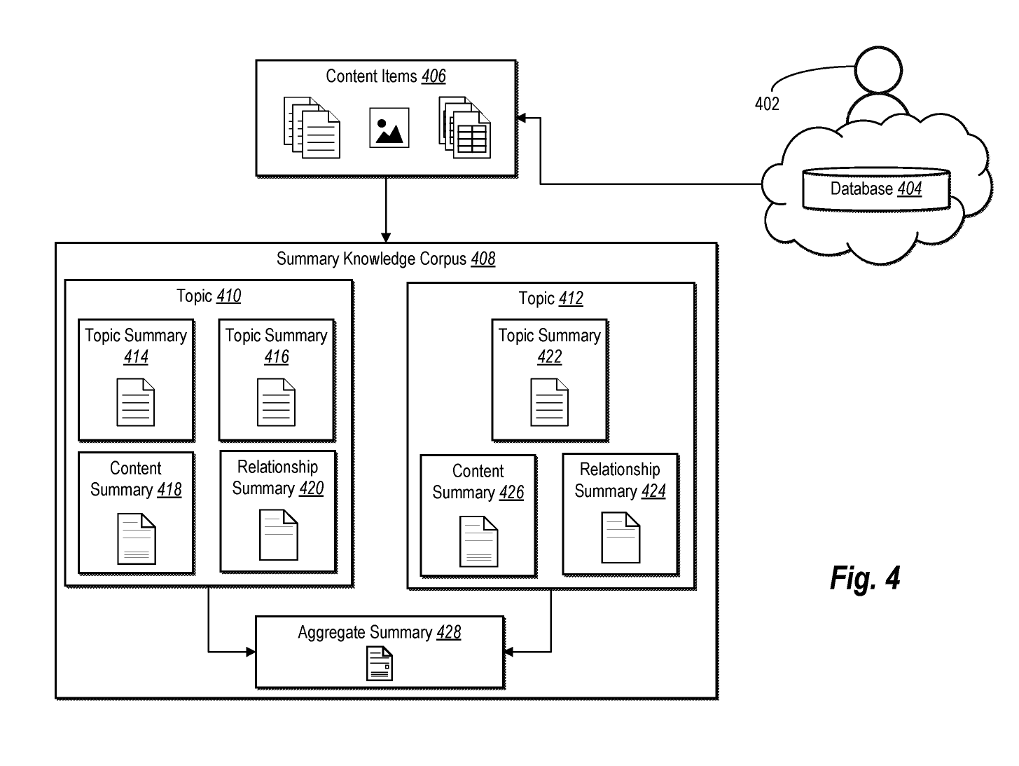

As previously discussed, the RAG knowledge system 106 can generate one or more topic summaries for a plurality of topics in a summary knowledge corpus. In one or more embodiments, the RAG knowledge system 106 can also house information, summaries, and/or descriptions about relationships between and/or among topics, content items, entities, and/or topic summaries. FIG. 4 illustrates the RAG knowledge system 106 determining relationships among content items and a plurality of topics, relationships among a plurality of topics, relationships among one or more content items and one or more entities, relationships among a plurality of topics and one or more entities, and relationships among one or more topic summaries in accordance with one or more embodiments.

As shown in FIG. 4, the RAG knowledge system 106 can access one or more content items 406 from a database 404 that is associated with an entity 402 (e.g., a user account or an organization account). As mentioned above and further illustrated in FIG. 4, the RAG knowledge system 106 can generate and/or store information, summaries, and/or descriptions about relationships between and/or among topics, content items, entities, and/or topic summaries in a summary knowledge corpus 408. Indeed, the RAG knowledge system 106 can link topics, content items, entities, and/or topic summaries in a quasi-knowledge graph that does not use edges or nodes but can be understood by a large language model to convey relationship information. For example, in one or more embodiments, the RAG knowledge system 106 can include references to topics and/or relationships in the one or more topic summaries 414, 416, 422. Indeed, in one or more embodiments, the RAG knowledge system 106 can include one or more additional topics and/or the relationships to those additional topics in the one or more topic summaries 414, 416, 422. For example, the one or more topic summaries 414, 416, 422 can include references to one or more additional topics that are related to the topics 410, 412. To further illustrate, in one or more embodiments, the topic summary 422 can summarize the major goals for a specific project (e.g., topic 412) performed by the entity 402 (e.g., project group). In some cases, the topic summary 422 can include references to prior projects (additional topics) performed by the entity 402 and/or the relationships of the prior project to the specific project (e.g., topic 412).

As shown in FIG. 4, in one or more embodiments, the RAG knowledge system 106 can further include relationship descriptions that define the relationships among the plurality of topics. To illustrate, in some cases, the relationship description can include information, entities, themes, dates, communications, etc. shared by the plurality of topics. As illustrated in FIG. 4, the summary knowledge corpus 408 can include a relationship description between topic 410 and topic 412. For example, the topic 410 can relate to sales figures for a quarter for the entity 402 and the topic 412 can correspond to an internal auditing project for the entity 402. In some implementations, the relationship description between the topic 410 and the topic 412 can include details about the auditing status for the sales figures for the quarter, individuals of the entity 402 that are involved in overseeing the sales and overseeing the auditing, important dates shared by the sales figures and internal auditing project, communications between individuals of the entity about the sales figures (e.g., topic 410) and the internal auditing project (e.g., topic 412) of the entity 402.

As further shown in FIG. 4, the RAG knowledge system 106 can generate relationship summaries 420, 424 defining the relationship between the entity 402 and the topics 410, 412 in the summary knowledge corpus 408. In one or more embodiments, the entity 402 can be an organization, group within an organization, and/or individuals within the organization. For example, the relationship summaries 420, 424 can include individuals and/or groups involved in the topic 410, 412, individuals and/or parties who generated the content items 406 from which the RAG knowledge system 106 extracted the topics 410, 412, and/or external entities (e.g., competitors, regulators, partners) referenced in the one or more topic summaries 414, 416, 422 and/or the content items 406 that may affect the topics 410, 412.

As FIG. 4 illustrates, the RAG knowledge system 106 can identify the entity 402 associated with the topic 410 of the one or more topic summaries 414, 416 and generate the relationship summary 420 that describes the relationship between the entity 402 and the topic 410. For example, the relationship summary 420 can define the role (e.g., CEO, CFO, manager, supervisor, etc.) of the entity. For example, building on the above example, the relationship summary can indicate if the entity 402 manages the department generating the sales figures for the quarter. Moreover, in one or more cases, based on the relationship between the entity 402 and the topic 410, the RAG knowledge system 106 can include the relationship summary 420 in the hybrid prompt. For example, if the relationship summary 420 shows an important and/or close relationship and/or role between the entity 402 and the topic 410, RAG knowledge system 106 can include the relationship summary 420 along with the topic summary 414 in the hybrid prompt.

As indicated in FIG. 4, the RAG knowledge system 106 can further generate and store one or more content summaries 418, 426 in the summary knowledge corpus 408. In one or more embodiments, the content summary can include additional relationship descriptions defining the relationships between the content items 406 within the content management system and the one or more topic summaries 414, 416, 422 for the topics 410, 412. For example, the additional summaries can identify which content items 406 the RAG knowledge system 106 relied on when generating and/or updating the one or more topic summaries 414, 416, 422 via the large language model. For example, building on the above examples, in one or more cases, the content summary 418 can include dates from sales receipts for the sales quarter and the importance and/or relevance of the sales receipts (e.g., content items 406) in relation to the one or more topic summaries 414, 416 summarizing the sales figures, sales goals, and/or sales projects for the quarter. Indeed, in one or more cases, the RAG knowledge system 106 can generate, via the large language model, one or more additional descriptions outlining the relationships between the content items 406 and the plurality of topics 410, 412 within the summary knowledge corpus 408.

Moreover, in one or more embodiments, the content summary 418 can include relationships between the content items 406 and the topics 410, 412 within the summary knowledge corpus 408. For example, the relationships between the content items 406 and the topics 410, 412 can indicate if, how, and/or when the RAG knowledge system 106 extracted the topics 410, 412 from the content items 406 by utilizing the large language model. Additionally, in some cases, the content summary 418 can include relationships indicating how or to what degree the content of the content items 406 defined, altered, and/or updated the topics 410, 412.

In one or more implementations, the content summary 418 can include information about the relationships between the content items 406 and the entity 402. For example, as shown in FIG. 4, the content items 406 can indicate if, when, and/or how the entity 402 generated, accessed, uploaded, and/or updated the content items 406. For example, the content summary 418 can show that a user account associated with the entity 402 modified a form outlining goals and actions for a project. Relatedly, in one or more embodiments, the content summary 418, can indicate if the content items 406 relate to more than one entity 402. For example, the content summary 418, 426 can include information about a first entity (e.g., first party) generating the content items 406 and a second entity (e.g., second party) editing and/or updating the content items 406.

Additionally, in one or more embodiments, the RAG knowledge system 106 can generate an aggregate summary 428. In particular, the RAG knowledge system 106 can generate the aggregate summary 428 of the topic summaries 414, 416, 422 or one or more topics 410, 412. For example, the RAG knowledge system 106 can utilize the large language model to generate the aggregate summary 428 that combines and/or describes the one or more topic summaries 414, 416, 422. In some cases, the aggregate summary 428 can combine topic summaries 414, 416, 422 from topics 410, 412 that differ. In some implementations, the RAG knowledge system 106 can instruct the large language model how combine the one or more topic summaries 414, 416, 422. For example, the RAG knowledge system 106 can cause the large language model to generate the aggregate summary 428 by combining the 20 most recent topic summaries or the 10 most relevant topic summaries of the one or more topics 410, 412. As just indicated, in one or more embodiments, the RAG knowledge system 106 can generate the aggregate summary 428 for one topic 410, 412.

In some cases, the RAG knowledge system 106 can generate the aggregate summary 428 by causing the large language model to combine the themes, subjects, and/or entities in the one or more topics 410, 412 into the aggregate summary 428. Moreover, as similarly discussed above in FIGS. 3A-3C, the RAG knowledge system 106 can generate the aggregate summary 428 at varying lengths.

Additionally, in one or more embodiments, the RAG knowledge system 106 can include the aggregate summary 428 in a hybrid prompt. For example, based on the prompt language, the RAG knowledge system 106 can include the aggregate summary 428 combining the topic summary 414, the topic summary 416, and the topic summary 422 in the hybrid prompt.

Relatedly, in one or more embodiments, the RAG knowledge system 106 can summarize one or more topic summaries 414, 416, 422. For example, in some implementations, the RAG knowledge system 106 can summarize all of the topic summaries 414, 416 for the topic 410. Relatedly, the RAG knowledge system 106 can summarize the topic summaries 414, 416, 412 from different topics 410, 412. Indeed, the RAG knowledge system 106 can iteratively generate summaries of summaries of topic summaries 414, 416, 422 to condense information in the summary knowledge corpus 408 to increase the retrieval speed of content items 406 during response generation.

In some embodiments, the RAG knowledge system 106 can identify changes in the one or more relationships among the plurality of topics 410, 412. Indeed, the RAG knowledge system 106 can detect changes to the one or more topics 410, 412 and determine how those changes affect one or more relationships among the topics 410, 412. For example, as discussed in more detail below, the RAG knowledge system 106 can update the one or more topics 410, 412 based on one or more new content items. In some cases, updating the one or more topics 410, 412 can change the relationships among the topics 410, 412, and the RAG knowledge system 106 can identify the changes of the one or more relationships among the topics 410, 412. In one or more cases, based on the change of the one or more relationships, the RAG knowledge system 106 can update the relationship descriptions defining the one or more relationships among the plurality of topics 410, 412.

As just discussed above, in one or more embodiments, the RAG knowledge system 106 can generate and/or monitor relationship among one or more topics, content items, entities, and/or topic summaries. In some embodiments, the RAG knowledge system 106 can further identify relevant (e.g., hot) topics for the entity 402. For example, the RAG knowledge system 106 can identify a frequency in which the RAG knowledge system 106 includes topic summaries 414, 416, 422 of the topics 410, 412 in the hybrid prompt for the entity 402. Based on the frequency of including the topic summaries 414, 416, 422 of the topics 410, 412 in the hybrid prompt, the RAG knowledge system 106 can label one or more topics 410, 412 as relevant (e.g., hot) topics for the entity. For example, if the RAG knowledge system 106 frequently and/or consistently includes topic summaries about “Project Leo” in the hybrid prompt, the RAG knowledge system 106 can determine that “Project Leo” is a relevant (or hot) topic.

In alternative embodiments, the RAG knowledge system 106 can label the topic 410, 412 as relevant for the entity 402 based on the prompt. In particular, the RAG knowledge system 106 can monitor the prompt language received from one or more client devices associated with the entity 402 by monitoring the frequency of words, phrases, people, dates, topics in the prompt language from the one or more client devices associated with the entity 402. Moreover, the RAG knowledge system 106 can determine based on the prompt language, the relevant topic for the entity 402. For example, if the prompt language from a group consistently uses the term “Project Leo”, the RAG knowledge system 106 can determine that “Project Leo” is a relevant topic to the group and based on the relevant topic label, prioritize monitoring, updating, and/or accessing Project Leo. In some implementations, the RAG knowledge system 106 can generate one or more topic summaries based on the relevant topic (e.g., Project Leo) and include those topic summaries to provide important context about Project Leo to the large language model when generating a response to the prompt.

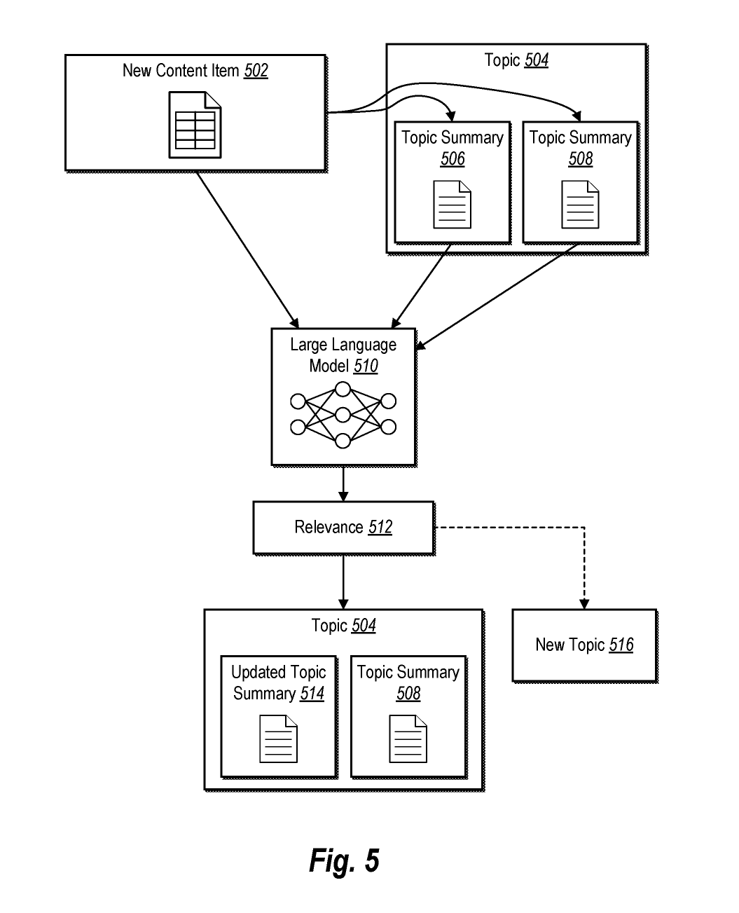

As just discussed, the RAG knowledge system 106 can generate and utilize relationships among one or more topics, content items, entities, and/or topic summaries to improve the prompt and response generated by a large language model. Moreover, as indicated above, in one or more embodiments, a new content item can affect one or more topics and/or topic summaries. FIG. 5 illustrates the RAG knowledge system 106 updating one or more topic summaries, topics, and/or generating a new topic based on a relevance of a new content item in accordance with one or more embodiments.

As illustrated in FIG. 5, the RAG knowledge system 106 can receive a new content item 502. In one or more embodiments, the RAG knowledge system 106 can determine a relationship between the new content item 502 one or more topic summaries 506, 508 for a topic 504. For example, the RAG knowledge system 106 can determine if the new content item 502 shares similar information (e.g., a similar topic, themes, data, entities, etc.) to the content in the topic summaries 506, 508.

As further shown in FIG. 5, the RAG knowledge system 106 can determine a relevance 512 of the new content item 502 in relation to the one or more topic summaries 506, 508 (e.g., by comparing an embedding of the new content item 502 with an embedding of the topic 504). In one or more embodiments, the relevance 512 of the new content item 502 can reflect the importance and/or the degree of connectedness of the new content item 502 in relation to the topic summaries 506, 508. Indeed, the RAG knowledge system 106 can utilize a large language model 510 to determine the relevance 512 of the new content item 502 in relation to the topic summaries 506, 508. In particular, the RAG knowledge system 106 can cause the large language model 510 to analyze the content of the new content item 502 and extract the themes, entities, subjects, and/or concepts from the new content item 502.

In one or more cases, the RAG knowledge system 106 can cause the large language model 510 to determine the relevance 512 of the extracted themes, entities, subjects, and/or concepts of the new content item 502 with regard to the one or more topic summaries 506, 508. For example, as further shown in FIG. 5, based on the relevance 512 of the new content item 502, the RAG knowledge system 106 can modify and/or update the one or more topic summaries 506, 508. For instance, based on determining that the relevance 512 of the new content item 502 is high for the topic summary 506, the RAG knowledge system 106 can modify the topic summary 506 and generate an updated topic summary 514. In some cases, the RAG knowledge system 106 updates the topic summary 506 by adding the content of the new content item 502. Indeed, in one or more implementations, the RAG knowledge system 106 can utilize the large language model 510 to add new information, remove irrelevant information, and/or correct information in the topic summary 506 based on the content of the new content item 502.

Additionally, in one or more embodiments, the RAG knowledge system 106 can update the length of the topic summary 506 based on the content of the new content item 502. In some cases, the updated topic summary 514 can have a different length than the topic summary 506. Indeed, the updated topic summary 514 can provide more accurate and up-to-date context regarding the topic 504. Alternatively, as shown in FIG. 5, in some cases, the new content item 502 does not modify one or more topic summaries. As illustrated by FIG. 5, based on the relevance 512 of the new content item 502 in relation to the topic summary 508, the RAG knowledge system 106 did not update and/or modify the topic summary 508.

Moreover, as FIG. 5 illustrates, the RAG knowledge system 106 can generate a new topic 516 based on the content of the new content item 502. For example, based on the relevance 512 of the new content item 502 and the topic summaries 506, 508 of the topic 504, the RAG knowledge system 106 can determine that the summary knowledge corpus should include the new topic 516. As described above, the RAG knowledge system 106 can utilize the large language model 510 to extract the themes, entities, subjects, and/or concepts from the content of the new content item 502. Moreover, the RAG knowledge system 106 can determine, utilizing the large language model 510, the relevance 512 of the new content item 502 in relation to the topic summaries 506, 508 and based on the relevance 512 generate the new topic 516. For example, in one or more embodiments, the RAG knowledge system 106 can determine that the new content item 502 is not relevant in relation to the topic summaries 506, 508. In some cases, the RAG knowledge system 106, via the large language model 510, can generate the new topic 516 that covers the main themes, entities, subjects, and/or concepts within the new content item 502.

Additionally, in one or more embodiments, the RAG knowledge system 106 can further determine the relevance 512 between the new content item 502 and one or more topics within the summary knowledge corpus and generate the new topic 516 based on the relevance 512 between the new content item 502 and one or more topics in the summary knowledge corpus. Relatedly, in one or more embodiments, the RAG knowledge system 106 can generate one or more new topic summaries for the new topic 516 and/or existing topics (e.g., topic 504). For example, as described above, the RAG knowledge system 106 can determine the relevance 512 between the new content item 502 and the topic 504. Moreover, based on the relevance 512 of the new content item 502, the RAG knowledge system 106 can generate a new topic summary for the topic 504 that covers the content of the new content item 502. For instance, the RAG knowledge system 106 can utilize the large language model 510 to determine that the new content item 502 is highly relevant to the topic 504. Based on the relevance 512 of the new content item 502, the RAG knowledge system 106 can generate the new topic summary that extracts the relevant content (e.g., information, data, themes) in the new content item 502.

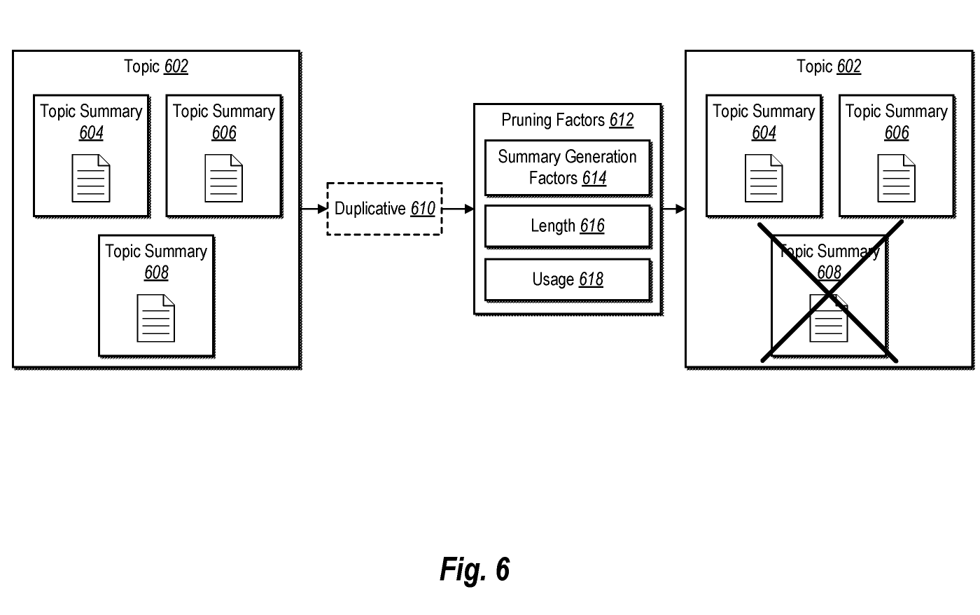

In one or more cases, as an entity (e.g., organization, group, individual) changes, the entity will add new content items, rely differently on topic summaries, and/or have different individuals and/or groups involved in various aspects of an organization. In some embodiments, the RAG knowledge system 106 can monitor and update the summary knowledge corpus so that the RAG model provides up-to-date and relevant information in the hybrid prompt so that the generated responses accurately reflect the changes in the entity. Indeed, the RAG knowledge system 106 can maintain the accuracy of the summary knowledge corpus, topics, and/or topic summaries by pruning, updating, and/or removing duplicative, unused, and/or outdated topic summaries from the summary knowledge corpus. FIG. 6 illustrates the RAG knowledge system 106 pruning one or more topic summaries in accordance with one or more embodiments.

As shown in FIG. 6, a topic 602 can have one or more topic summaries 604, 606, 608. Moreover, as just mentioned, the RAG knowledge system 106 can remove duplicative, out-of-date, and/or unused summaries. As FIG. 6 further illustrates, in one or more cases, the RAG knowledge system 106 can utilize one or more pruning factors to determine which of the one or more topic summaries 604, 606, 608 to keep. For example, in one or more embodiments, the RAG knowledge system 106 can look at summary generation factors 614, the length 616 of the one or more topic summaries 604, 606, 608, and/or usage 618 of the one or more topic summaries 604, 606, 608.

As just indicated, the RAG knowledge system 106 can apply summary generation factors 614 that weight the one or more topic summaries 604, 606, 608. For example, the summary generation factors 614 can include a factor regarding the originating party (e.g., entity) that created the content item(s) from which the RAG knowledge system 106 generated the one or more topic summaries 604, 606, 608. To illustrate, based on the involvement, status, and/or title of the originating party that created the content item(s), the RAG knowledge system 106 can apply a weight indicating whether to keep or remove the one or more topic summaries 604, 606, 608. For example, based on the role of the originating party involved in creating the content item(s) that fed into the one or more topic summaries 604, 606, 608, the RAG knowledge system 106 can apply a weight that leans in or out of favor of keeping the one or more topic summaries 604, 606, 608. To illustrate, based on the involved, managerial role of the originating party that generated the content items for a project that informed a topic summary about the project, the RAG knowledge system 106 can apply a weight that weighs in favor of keeping the topic summary about the project.

Additionally, in one or more embodiments, the summary generation factors 614 can include a generation date when the RAG knowledge system 106 generated the one or more topic summaries 604, 606, 608. For instance, the topic summary 608 with an older generation date than the generation dates of the topic summaries 604, 606 can indicate that the topic summary 608 is less relevant than the topic summaries 604, 606. Indeed, based on the generation date of the topic summary 608, the RAG knowledge system 106 can determine if the generation dates of the topic summary 604 and the topic summary 606 provide more accurate context and/or information in the hybrid prompt.

Moreover, in some implementations, the summary generation factors 614 can include the formation date for one or more content items from which the RAG knowledge system 106 generated the topic summaries 604, 606, 608. As indicated above, the RAG knowledge system 106 can apply weights to the topic summaries 604, 606, 608 based on the formation date of the one or more content items that informed the topic summaries 604, 606, 608. The formation date can indicate the relevance and/or accuracy of content items informing the topic summaries 604, 606, 608. For example, a more recent formation date of the topic 602 can indicate more up-to-date information and based on the more recent date of the content items feeding the topic summary 604, the RAG knowledge system 106 can apply weights that favor keeping the topic summary 604 and removing the topic summary 608.

In one or more embodiments, once the RAG knowledge system 106 generates the weights for the topic summaries based on the one or more generation factors associated with the topic summaries 604, 606, 608, the RAG knowledge system 106 can compare the weights of the topic summaries 604, 606, 608 and determine whether to keep or remove one or more of the topic summaries 604, 606, 608.

As further shown in FIG. 6, the RAG knowledge system 106 can remove a subset of topic summaries. For example, the RAG knowledge system 106 can determine a weight threshold for the weights of the topic summaries 604, 606, 608 and remove a subset of the topic summaries that fall below a weight threshold. For instance, the RAG knowledge system 106 can keep the topic summaries 604, 606 over the topic summary 608 because the summary generation factors 614 indicated that the topic summaries 604, 606 have a heaver importance, relevance, and/or accuracy by not falling below the weight threshold. For example, as shown in FIG. 6, the RAG knowledge system 106 can remove the topic summary 608 from the topic 602 because the weight of the topic summary 608 fell below the weight threshold indicating that the topic summary 608 was less important, relevant, and/or accurate than the topic summaries 604, 606.

As further shown in FIG. 6, in one or more embodiments, the one or more pruning factors 612 can include analyzing the length 616 of the topic summaries 604, 606, 608. In particular, based on the length 616 of the topic summaries 604, 606, 608, the RAG knowledge system 106 can determine whether to keep or remove the topic summary 604, 606, 608 from the topic 602. For example, in one or more cases, based on a short length of the topic summary 608, the RAG knowledge system 106 can determine that the topic summary 608 is unnecessary and remove the topic summary 608 from the topic 602 in the summary knowledge corpus.

Moreover, in one or more cases, the pruning factors 612 can include looking at the usage 618 of the topic summaries 604, 606, 608. In particular, the RAG knowledge system 106 can monitor the usage 618 of the topic summaries 604, 606, 608 by an entity. For example, the RAG knowledge system 106 can monitor how often the hybrid prompts received by a client device associated with the entity include and/or rely on the topic summary 608. As shown in FIG. 6, based on low usage and/or reliance on the topic summary 608, the RAG knowledge system 106 can remove the topic summary 608 from the topic 602 within the summary knowledge corpus.

Indeed, in one or more embodiments, the RAG knowledge system 106 can monitor the usage of one or more topic summaries 604, 606, 608 for a plurality of topics within the summary knowledge corpus and remove a subset of topic summaries from the plurality of topics that go unused for a certain amount of time and/or fall below a usage threshold. For example, the RAG knowledge system 106 can remove one or more topic summaries 604, 606, 608 that have not been included in a hybrid prompt for a certain amount of time (e.g., 1 month, 3 months, 6 months, 1 year, etc.). In some embodiments, the RAG knowledge system 106 can set a usage threshold and remove the one or more topic summaries that fall below the usage threshold. For example, if the usage threshold is two uses of the topic summary in the hybrid prompt and the RAG knowledge system 106 only includes the topic summary 608 once in the hybrid prompt, the RAG knowledge system 106 can remove the topic summary 608 from the topic 602 and the summary knowledge corpus.

In one or more embodiments, the pruning factors 612 can include a large language model. In particular, the RAG knowledge system 106 can instruct the large language model to determine to remove and/or edit the one or more topic summaries 604, 606, 608 and/or topics from the summary knowledge corpus. For example, the large language model can analyze the content of the one or more topic summaries 604, 606, 608 and/or topics and determine if the one or more topic summaries 604, 606, 608 and/or topics are relevant. In some cases, the RAG knowledge system 106 can cause the large language model to analyze other pruning factors when determining whether or not to remove and/or edit one or more topic summaries 604, 606, 608 and/or topics.

In one or more cases, the RAG knowledge system 106 can rely on one or more of the one or more pruning factors 612 while determining if and when to remove one or more topic summaries 604, 606, 608 from the summary knowledge corpus. For example, in one or more embodiments, the RAG knowledge system 106 can utilize the summary generation factors 614 and the usage 618 of the topic summary 608 when determining to remove the topic summary 608 from the summary knowledge corpus. In some embodiments, the RAG knowledge system 106 can likewise remove one or more topics from the summary knowledge corpus based on the pruning factors 612.

As just described, in one or more embodiments, the RAG knowledge system 106 can remove one or more topic summaries 604, 606, 608 from the summary knowledge corpus. In one or more embodiments, the RAG knowledge system 106 can identify one or more duplicative 610 topic summaries 604, 606, 608 and determine of the duplicative summaries to remove by applying the pruning factors 612. For example, in one or more implementations, the RAG knowledge system 106 can determine that the topic summary 608 is duplicative by extracting topic summary embeddings from the topic summary 608, the topic summary 604, and the topic summary 606 and comparing the topic summary embeddings of the topic summary 608 with the topic summary embeddings of the topic summary 604 and the topic summary embeddings of the topic summary 606. In one or more cases, the RAG knowledge system 106 can determine that the topic summary 608 is duplicative 610 if the topic summary embeddings of the topic summary 608 are within a topic summary distance threshold with the topic summary embeddings of the topic summaries 604 and 606.

Moreover, based on the topic summary 608 being duplicative 610 of the topic summary 604, the RAG knowledge system 106 can utilize the pruning factors 612 to determine whether to keep the topic summary 604 over the topic summary 608. Indeed, as described above, based on the originating party, formation dates of content items, generation dates of topic summaries, length 616 of the topic summaries 604, 608, and/or usage of the topic summaries 604, 608, the RAG knowledge system 106 can apply weights to the topic summaries 604, 608 and based on the weights, remove the topic summary 608 from the summary knowledge corpus. In one or more embodiments, the RAG knowledge system 106 can iteratively monitor the summary knowledge corpus to remove duplicative 610 topic summaries. By maintaining the summary knowledge corpus through pruning, adding, and modifying topic summaries as described, the RAG knowledge system 106 can preserve computer memory and storage resources, thus improving data usage over prior systems.

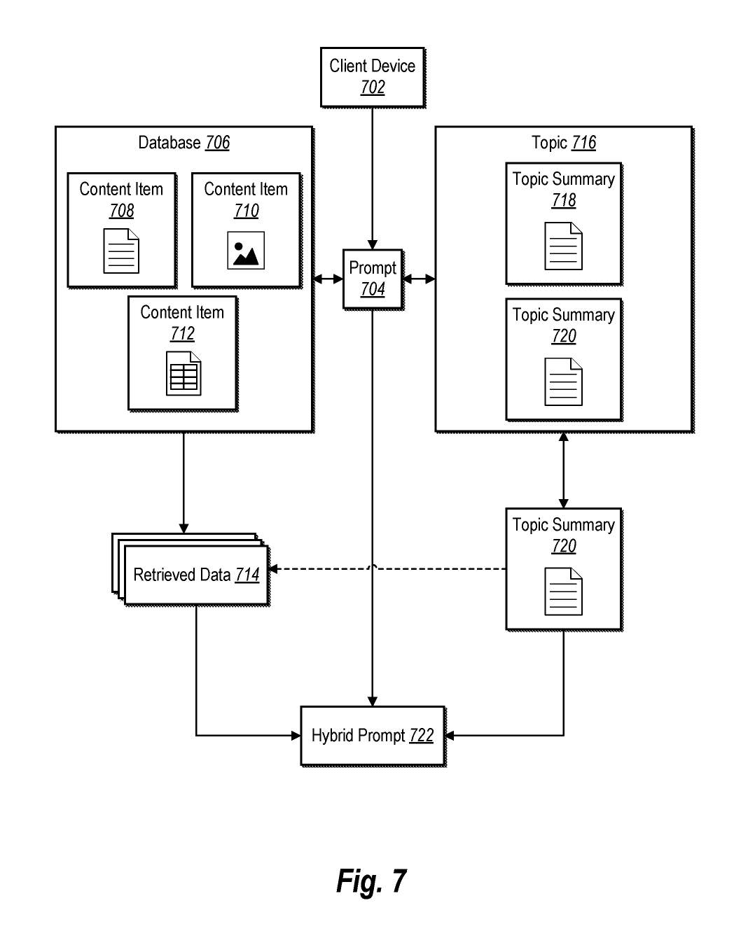

As discussed above, the RAG knowledge system 106 can provide context to a large language model of a RAG model while generating a response to a prompt (e.g., query) by providing a hybrid prompt to the large language model. FIG. 7 illustrates the RAG knowledge system 106 generating a hybrid prompt in accordance with one or more embodiments.

As shown in FIG. 7, during a runtime for a RAG model, the RAG knowledge system 106 can receive a prompt 704 with prompt language from a client device 702. In response to receiving the prompt 704, the RAG knowledge system 106 can determine if one or more topic summaries 718, 720 of a topic 716 corresponds with the prompt language. Moreover, the RAG knowledge system 106 can compare the prompt with one or more content items 708, 710, 712 from a database 706 associated with the entity by employing the RAG model. In particular, the RAG knowledge system 106 can compare the one or more embeddings (e.g., vectorized segments) of the prompt 704 with the one or more embeddings (e.g., vectorized segments) of the one or more content items 708, 710, 712 stored in the database 706. Based on the comparison, the RAG knowledge system 106 can generate the retrieved data 714 via the RAG model. In one or more embodiments, the retrieved data 714 can include one or more data contexts and/or one or more embeddings (e.g., vectorized segments) of the one or more content items 708, 710, 712 that correspond to the prompt 704. Moreover, while not illustrated in FIG. 7, in one or more cases, the database 706 can also store the topic 716 and/or topic summaries 718, 720.

As further shown in FIG. 7, the RAG knowledge system 106 can generate a hybrid prompt 722 by combining the retrieved data 714 accessed by the RAG model during the runtime in response to the prompt language with the topic summary 720. In some embodiments, as shown in FIG. 7, the RAG knowledge system 106 can include some and/or all of the language from the prompt 704 in the hybrid prompt 722.

In some cases, the RAG knowledge system 106 can prioritize the order (e.g., rank) the one or more topic summaries and the retrieved data 714. In particular, the RAG knowledge system 106 can provide the topic summaries and/or the retrieved data 714 to the large language model of the RAG model according to the ranking. For example, in one or more embodiments, the topic summaries are more information dense than the retrieved data 714 of the one or more content items 708, 710, 712. Additionally, in one or more embodiments, the RAG knowledge system 106 can include the topic summary 720 at a certain length based on its rank. For example, the length of topic summary 720 can be longer based on having the highest rank among the one or more topic summaries in the summary knowledge corpus. Relatedly, in some implementations, the RAG knowledge system 106 can include one or more additional topic summaries with certain lengths in the hybrid prompt 722 based on their rankings. For instance, topic summaries with a lower rank can have shorter lengths, whereas, topic summaries with a higher rank can have longer length. Indeed, y providing the topic summaries and retrieved data 714 in the ranked order, the RAG knowledge system 106 can ensure that the large language model of the RAG model has the relevant background and/or context needed to generate a relevant, up-to-date, and accurate response.

In some cases, the RAG knowledge system 106 can generate one or more tokens corresponding to the topic 716 and embed the one or more tokens into one or more embeddings of the one or more content items 708, 710, 712. For example, the RAG knowledge system 106 can insert the one or more tokens into the one or more embeddings of the one or more content items 708, 710, 712 that are most relevant to the topic summary 720. In some cases, the RAG knowledge system 106 can utilize the one or more tokens embedded in the one or more embeddings of the one or more content items 708, 710, 712 to pull the one or more embeddings of the one or more content items 708, 710, 712 closer to the topic 716 to ensure that the one or more embeddings of the one or more content items 708, 710, 712 are included in the hybrid prompt 722. Indeed, the hybrid prompt 722 can provide an augmented prompt that supplies context (e.g., an information dense understanding) of the topic to the large language model in the RAG model.

As indicated in FIG. 7, the RAG knowledge system 106 can utilize a multi-step process to inform subsequent retrieval steps. For example, in one or more embodiments, the RAG knowledge system 106 can utilize a large language model to select one or more content items 708, 710, 712 based on analyzing and/or being informed by one or more topic summaries 718, 720. For example, the RAG knowledge system 106 can utilize the large language model to select the content item 710 and/or one or more portions of the content item 708 to be included in the retrieved data 714 based on informing the large language model with the topic summary 720. Indeed, based on informing the large language model with the topic summary 720, the RAG knowledge system 106 can cause the large language model to be informed by one or more additional topic summaries while retrieving content items 708, 710, 712 and/or portions of the content items 708, 710, 712 for the retrieved data 714. In some cases, based on informing the large language model with the topic summary 720, the RAG knowledge system 106 can cause the large language model to include one or more additional topic summaries in the hybrid prompt 722.

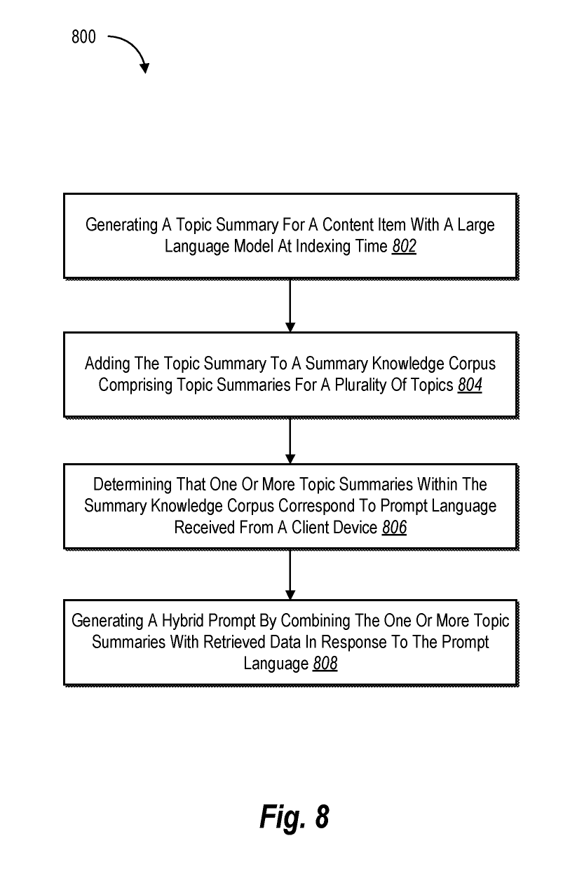

FIGS. 1-7, the corresponding text, and the examples provide a number of different systems and methods for processing data from a computer application utilizing a coordinator and connectors. In addition to the foregoing, implementations can also be described in terms of flowcharts comprising acts/steps in a method for accomplishing a particular result. For example, FIG. 8 illustrates a flowchart of a series of acts for ingesting a subset of data included in a page after a failure point of a transfer run indicated by a cursor location in accordance with one or more embodiments.

As illustrated in FIG. 8, the series of acts 800 may include an act 802 of generating a topic summary for a content item with a large language model at indexing time. For example, in one or more embodiments, the act 802 can include generating, utilizing a large language model at indexing time of a content item within a content management system, a topic summary for a topic within the content item. In addition, the series of acts 800 includes an act 804 of adding the topic summary to a summary knowledge corpus comprising topic summaries for a plurality of topics. For example, in one or more embodiments, the act 804 can include adding the topic summary to a summary knowledge corpus comprising topic summaries for a plurality of topics extracted from content items within the content management system, wherein the summary knowledge corpus further comprises relationship descriptions defining relationships among the plurality of topics. In addition, the series of acts 800 includes an act 806 of determining that one or more topic summaries within the summary knowledge corpus correspond to prompt language received from a client device. For instance, in some implementations, the act 806 can include determining, at runtime for a retrieval augmented generation (RAG) model in response to receiving prompt language from a client device, one or more topic summaries corresponding to the prompt language from the summary knowledge corpus. As further illustrated in FIG. 8, the series of acts 800 includes an act 808 of, generating a hybrid prompt by combining the one or more topic summaries with retrieved data in response to the prompt language. For example, the act 808 can include generating a hybrid prompt for the RAG model by combining the one or more topic summaries with retrieved data accessed by the RAG model in response to the prompt language.

Further, in one or more embodiments, the series of acts 800 includes receiving a new content item within the content management system. In addition, in one or more embodiments, the series of acts 800 includes determining a relationship between the new content item and the one or more topic summaries. Additionally, the series of acts 800 can include determining, utilizing the large language model, a relevance of the new content item in relation to the one or more topic summaries. In some cases, the series of acts 800 can include based on the relevance of the new content item, updating the one or more topic summaries with content of the new content item.

Furthermore, in one or more embodiments, the series of acts 800 includes generating, for the topic, the topic summary at a first length. Additionally, in one or more embodiments, the series of acts 800 includes generating, for the topic, an additional topic summary at a second length different from the first length. In some cases, the series of acts 800 includes storing the topic summary and the additional topic summary for the topic in the summary knowledge corpus.

Moreover, in one or more embodiments, the series of acts 800 includes generating an aggregate summary of one or more topic summaries. In some instances, the series of acts 800 includes including the aggregate summary in the hybrid prompt.

Additionally, in one or more embodiments, the series of acts 800 includes identifying an entity associated with the topic of the topic summary. In one or more embodiments, the series of acts 800 includes generating a relationship summary defining a relationship between the entity and the topic of the topic summary. Moreover, in one or more embodiments, the series of acts 800 includes based on the relationship between the entity and the topic of the topic summary, including the relationship summary in the hybrid prompt.

Additionally, in one or more embodiments, the series of acts 800 includes pruning, within the content management system, at least one topic summary from the summary knowledge corpus by determining one or more summary generation factors associated with the topic summaries. In some cases, the series of acts 800 includes generating weights for the topic summaries based on the one or more summary generation factors. Moreover, the series of acts 800 can include comparing the weights of the topic summaries. In some cases, the series of acts 800 can include removing a subset of the topic summaries that fall below a weight threshold from the summary knowledge corpus.

Furthermore, in one or more embodiments, the series of acts 800 includes where determining the one or more topic summaries corresponding to the prompt language further comprises determining a relevance score for a topic summary by comparing an embedding of the topic summary to an embedding of the prompt language received from the client device. In addition, in one or more embodiments, the series of acts 800 includes determining, based on the relevance score, including the topic summary in the hybrid prompt.

Additionally, in one or more embodiments, the series of acts 800 includes generating, utilizing a large language model at indexing time of a content item within a content management system, a topic summary for a topic within the content item. In addition, in one or more embodiments, the series of acts 800 includes adding the topic summary to a summary knowledge corpus comprising topic summaries for a plurality of topics extracted from content items within the content management system, wherein the summary knowledge corpus further comprises relationship descriptions defining relationships among the plurality of topics. Furthermore, in one or more embodiments, the series of acts 800 includes determining, at runtime for a retrieval augmented generation (RAG) model in response to receiving prompt language from a client device, a relevance score for one or more topic summaries corresponding to the prompt language from the summary knowledge corpus. In addition, in one or more embodiments, the series of acts 800 includes generating a hybrid prompt for the RAG model by combining, according to the relevance score, the one or more topic summaries with retrieved data accessed by the RAG model in response to the prompt language

In addition, in one or more embodiments, the series of acts 800 includes receiving a new content item within the content management system. Moreover, the series of acts 800 includes determining a relationship between the new content item and the one or more topic summaries. In one or more implementations, the series of acts 800 includes determining, utilizing the large language model, a relevance of the new content item in relation to the one or more topic summaries. In some cases, the series of acts 800 includes based on the relevance of the new content item, generating a new topic summary based on content of the new content item.

Moreover, in one or more embodiments, the series of acts 800 includes generating the summary knowledge corpus by generating additional relationship descriptions defining relationships between the content items within the content management system and the topic summaries for the plurality of topics.

In addition, in one or more embodiments, the series of acts 800 includes, monitoring the prompt language received from one or more client devices associated with an entity within the content management system. Furthermore, in one or more embodiments, the series of acts 800 includes determining, based on the prompt language, a relevant topic for the entity. Moreover, in one or more embodiments, the series of acts 800 includes generating one or more topic summaries based on the relevant topic.

Additionally, in one or more embodiments, the series of acts 800 includes an act determining the relevance score of one or more topic summaries further comprises comparing one or more embeddings of the one or more topic summaries to an embedding of the prompt language received from the client device. Further, in one or more embodiments, the series of acts 800 includes including references to one or more additional topics or relationships to the one or more additional topics in the topic summary.

Moreover, in one or more embodiments, the series of acts 800 includes generating an embedding of the topic and an embedding of the prompt language received from the client device. In some implementations, the series of acts 800 includes determining a distance between the embedding of the topic and the embedding of the prompt language by comparing the embedding of the topic with the embedding of the prompt language. In some cases, the series of acts 800 includes determining a length of the topic summary for the topic based on the distance between the embedding of the topic and the embedding of the prompt language. In one or more implementations, the series of acts 800 includes including the topic summary according to the determined length in the hybrid prompt.

Additionally, in one or more embodiments, the series of acts 800 includes generating, utilizing a large language model at indexing time of a content item within a content management system, a topic summary for a topic within the content item. Further, in one or more embodiments, the series of acts 800 includes adding the topic summary to a summary knowledge corpus comprising topic summaries for a plurality of topics extracted from content items within the content management system. Moreover, in one or more embodiments, the series of acts 800 includes determining, at runtime for a retrieval augmented generation (RAG) model in response to receiving prompt language from a client device, one or more topic summaries corresponding to the prompt language from the summary knowledge corpus. In addition, in one or more embodiments, the series of acts 800 includes generating a hybrid prompt for the RAG model by combining the one or more topic summaries with retrieved data accessed by the RAG model in response to the prompt language.

Moreover, in one or more embodiments, the series of acts 800 includes monitoring, within the content management system, usage of the topic summaries for the plurality of topics within the summary knowledge corpus by an entity. In addition, in one or more embodiments, the series of acts 800 includes removing, based on the usage of the topic summaries for the plurality of topics, a subset of the topic summaries from the plurality of topics.

Additionally, in one or more embodiments, the series of acts 800 includes generating for the topic a first topic summary corresponding to a first length and a second topic summary corresponding to a second length. Moreover, in one or more embodiments, the series of acts 800 includes receiving additional prompt language from the client device. Further, in one or more embodiments, the series of acts 800 includes based on the additional prompt language, including the second topic summary in the hybrid prompt.

Additionally, in one or more embodiments, the series of acts 800 includes an act where the summary knowledge corpus further comprises one or more of relationship descriptions defining relationships among the plurality of topics, relationship summaries defining relationships between one or more entities and the plurality of topics, relationships between one or more content items and the plurality of topics, or relationships between one or more content items and the one or more entities.

Moreover, in one or more embodiments, the series of acts 800 includes identifying a change of one or more relationships among the plurality of topics. In addition, in one or more embodiments, the series of acts 800 includes based on the change of the one or more relationships, updating relationship descriptions defining the one or more relationships among the plurality of topics. Furthermore, in one or more embodiments, the series of acts 800 includes determining to update the topic summaries for the plurality of topics by utilizing an additional large language model.

In one or more implementations, each of the components of the RAG knowledge system 106 are in communication with one another using any suitable communication technologies. Additionally, the components of the RAG knowledge system 106 can be in communication with one or more other devices including one or more client devices described above. It will be recognized that in as much the RAG knowledge system 106 is shown to be separate in the above description, any of the subcomponents may be combined into fewer components, such as into a single component, or divided into more components as may serve a particular implementation.

FIG. 9 illustrates a block diagram of exemplary computing device 900 that may be configured to perform one or more of the processes described above. The components of the RAG knowledge system 106 can include software, hardware, or both. For example, the components of the RAG knowledge system 106 can include one or more instructions stored on a computer-readable storage medium and executable by processors of one or more computing devices (e.g., the computing device 900). When executed by the one or more processors, the computer-executable instructions of the RAG knowledge system 106 can cause the computing device 900 to perform the methods described herein. Alternatively, the components of the RAG knowledge system 106 can comprise hardware, such as a special purpose processing device to perform a certain function or group of functions. Additionally, or alternatively, the components of the RAG knowledge system 106 can include a combination of computer-executable instructions and hardware.

Furthermore, the components of the RAG knowledge system 106 performing the functions described herein may, for example, be implemented as part of a stand-alone application, as a module of an application, as a plug-in for applications including content management applications, as a library function or functions that may be called by other applications, and/or as a cloud-computing model. Thus, the components of the RAG knowledge system 106 may be implemented as part of a stand-alone application on a personal computing device or a mobile device.

Implementations of the present disclosure may comprise or utilize a special purpose or general-purpose computer including computer hardware, such as, for example, one or more processors and system memory, as discussed in greater detail below. Implementations within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, implementations of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some implementations, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multiprocessor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Implementations of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

As mentioned, FIG. 9 illustrates a block diagram of exemplary computing device 900 that may be configured to perform one or more of the processes described above. One will appreciate that third-party server(s) 102, the client device(s) 110, and/or the computing device 900 may comprise one or more computing devices such as computing device 900. As shown by FIG. 9, computing device 900 can comprise processor 902, memory 904, a storage device, a I/O interface, and communication interface 910, which may be communicatively coupled by way of communication infrastructure 912. While an exemplary computing device 900 is shown in FIG. 9, the components illustrated in FIG. 9 are not intended to be limiting. Additional or alternative components may be used in other implementations. Furthermore, in certain implementations, computing device 900 can include fewer components than those shown in FIG. 9. Components of computing device 900 shown in FIG. 9 will now be described in additional detail.

In particular implementations, processor 902 includes hardware for executing instructions, such as those making up a computer program. As an example, and not by way of limitation, to execute instructions, processor 902 may retrieve (or fetch) the instructions from an internal register, an internal cache, memory 904, or storage device 906 and decode and execute them. In particular implementations, processor 902 may include one or more internal caches for data, instructions, or addresses. As an example, and not by way of limitation, processor 902 may include one or more instruction caches, one or more data caches, and one or more translation lookaside buffers (TLBs). Instructions in the instruction caches may be copies of instructions in memory 904 or storage device 906.

Memory 904 may be used for storing data, metadata, and programs for execution by the processor(s). Memory 904 may include one or more of volatile and non-volatile memories, such as Random Access Memory (“RAM”), Read Only Memory (“ROM”), a solid-state disk (“SSD”), Flash, Phase Change Memory (“PCM”), or other types of data storage. Memory 904 may be internal or distributed memory.

Storage device 906 includes storage for storing data or instructions. As an example, and not by way of limitation, storage device 906 can comprise a non-transitory storage medium described above. Storage device 906 may include a hard disk drive (HDD), a floppy disk drive, flash memory, an optical disc, a magneto-optical disc, magnetic tape, or a Universal Serial Bus (USB) drive or a combination of two or more of these. Storage device 906 may include removable or non-removable (or fixed) media, where appropriate. Storage device 906 may be internal or external to computing device 900. In particular implementations, storage device 906 is non-volatile, solid-state memory. In other implementations, Storage device 906 includes read-only memory (ROM). Where appropriate, this ROM may be mask programmed ROM, programmable ROM (PROM), erasable PROM (EPROM), electrically erasable PROM (EEPROM), electrically alterable ROM (EAROM), or flash memory or a combination of two or more of these.

I/O interface 908 allows a user to provide input to, receive output from, and otherwise transfer data to and receive data from computing device 900. I/O interface 908 may include a mouse, a keypad or a keyboard, a touch screen, a camera, an optical scanner, network interface, modem, other known I/O devices or a combination of such I/O interfaces. I/O interface 908 may include one or more devices for presenting output to a user, including, but not limited to, a graphics engine, a display (e.g., a display screen), one or more output drivers (e.g., display drivers), one or more audio speakers, and one or more audio drivers. In certain implementations, I/O interface 908 is configured to provide graphical data to a display for presentation to a user. The graphical data may be representative of one or more graphical interfaces and/or any other graphical content as may serve a particular implementation.

Communication interface 910 can include hardware, software, or both. In any event, communication interface 910 can provide one or more interfaces for communication (such as, for example, packet-based communication) between computing device 900 and one or more other computing devices or networks. As an example and not by way of limitation, communication interface 910 may include a network interface controller (NIC) or network adapter for communicating with an Ethernet or other wire-based network or a wireless NIC (WNIC) or wireless adapter for communicating with a wireless network, such as a WI-FI.

Additionally or alternatively, communication interface 910 may facilitate communications with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, communication interface 910 may facilitate communications with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination thereof.

Additionally, communication interface 910 may facilitate communications various communication protocols. Examples of communication protocols that may be used include, but are not limited to, data transmission media, communications devices, Transmission Control Protocol (“TCP”), Internet Protocol (“IP”), File Transfer Protocol (“FTP”), Telnet, Hypertext Transfer Protocol (“HTTP”), Hypertext Transfer Protocol Secure (“HTTPS”), Session Initiation Protocol (“SIP”), Simple Object Access Protocol (“SOAP”), Extensible Mark-up Language (“XML”) and variations thereof, Simple Mail Transfer Protocol (“SMTP”), Real-Time Transport Protocol (“RTP”), User Datagram Protocol (“UDP”), Global System for Mobile Communications (“GSM”) technologies, Code Division Multiple Access (“CDMA”) technologies, Time Division Multiple Access (“TDMA”) technologies, Short Message Service (“SMS”), Multimedia Message Service (“MMS”), radio frequency (“RF”) signaling technologies, Long Term Evolution (“LTE”) technologies, wireless communication technologies, in-band and out-of-band signaling technologies, and other suitable communications networks and technologies.

Communication infrastructure 912 may include hardware, software, or both that couples components of computing device 900 to each other. As an example and not by way of limitation, communication infrastructure 912 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination thereof.

FIG. 10 is a schematic diagram illustrating environment 1000 within which one or more implementations of the RAG knowledge system 106 can be implemented. As discussed above with respect to FIG. 1, in some embodiments the RAG knowledge system 106 can be part of a content management system 1002. In one or more embodiments, the content management system 1002 may generate, store, manage, receive, and send digital content (such as digital videos). For example, content management system 1002 may send and receive digital content to and from the user client device 1006 by way of network 1004. In particular, the content management system 1002 can store and manage a collection of digital content. The content management system 1002 can manage the sharing of digital content between computing devices associated with a plurality of users. For instance, the content management system 1002 can facilitate a user sharing a digital content with another user of content management system 1002.

In particular, the content management system 1002 can manage synchronizing digital content across multiple of the user client device 1006 associated with one or more users. For example, a user may edit digital content using user client device 1006. The content management system 1002 can cause user client device 1006 to send the edited digital content to content management system 1002. Content management system 1002 then synchronizes the edited digital content on one or more additional computing devices.

In addition to synchronizing digital content across multiple devices, one or more implementations of content management system 1002 can provide an efficient storage option for users that have large collections of digital content. For example, content management system 1002 can store a collection of digital content on content management system 1002, while the user client device 1006 only stores reduced-sized versions of the digital content. A user can navigate and browse the reduced-sized versions (e.g., a thumbnail of a digital image) of the digital content on user client device 1006. In particular, one way in which a user can experience digital content is to browse the reduced-sized versions of the digital content on user client device 1006.

Another way in which a user can experience digital content is to select a reduced-size version of digital content to request the full- or high-resolution version of digital content from content management system 1002. In particular, upon a user selecting a reduced-sized version of digital content, user client device 1006 sends a request to content management system 1002 requesting the digital content associated with the reduced-sized version of the digital content. Content management system 1002 can respond to the request by sending the digital content to user client device 1006. User client device 1006, upon receiving the digital content, can then present the digital content to the user. In this way, a user can have access to large collections of digital content while minimizing the amount of resources used on user client device 1006.

User client device 1006 may be a desktop computer, a laptop computer, a tablet computer, a personal digital assistant (PDA), an in- or out-of-car navigation system, a handheld device, a smart phone or other cellular or mobile phone, or a mobile gaming device, other mobile device, or other suitable computing devices. User client device 1006 may execute one or more client applications, such as a web browser (e.g., Microsoft Windows Internet Explorer, Mozilla Firefox, Apple Safari, Google Chrome, Opera, etc.) or a native or special-purpose client application (e.g., Dropbox Paper for iPhone or iPad, Dropbox Paper for Android, etc.), to access and view content over network 1004.

Network 1004 may represent a network or collection of networks (such as the Internet, a corporate intranet, a virtual private network (VPN), a local area network (LAN), a wireless local area network (WLAN), a cellular network, a wide area network (WAN), a metropolitan area network (MAN), or a combination of two or more such networks) over which user client devices 1006 may access content management system 1002.

In the foregoing specification, the present disclosure has been described with reference to specific exemplary implementations thereof. Various implementations and aspects of the present disclosure(s) are described with reference to details discussed herein, and the accompanying drawings illustrate the various implementations. The description above and drawings are illustrative of the disclosure and are not to be construed as limiting the disclosure. Numerous specific details are described to provide a thorough understanding of various implementations of the present disclosure.

The present disclosure may be embodied in other specific forms without departing from its spirit or essential characteristics. The described implementations are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the present application is, therefore, indicated by the appended claims rather than by the foregoing description. All changes that come within the meaning and range of equivalency of the claims are to be embraced within their scope.

The foregoing specification is described with reference to specific exemplary implementations thereof. Various implementations and aspects of the disclosure are described with reference to details discussed herein, and the accompanying drawings illustrate the various implementations. The description above and drawings are illustrative and are not to be construed as limiting. Numerous specific details are described to provide a thorough understanding of various implementations.

The additional or alternative implementations may be embodied in other specific forms without departing from its spirit or essential characteristics. The described implementations are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A computer-implemented method comprising:
generating, utilizing a large language model at indexing time of a content item within a content management system, a topic summary for a topic within the content item;
adding the topic summary to a summary knowledge corpus comprising topic summaries for a plurality of topics extracted from content items within the content management system, wherein the summary knowledge corpus further comprises relationship descriptions defining relationships among the plurality of topics;
determining, at runtime for a retrieval augmented generation (RAG) model in response to receiving prompt language from a client device, one or more topic summaries corresponding to the prompt language from the summary knowledge corpus; and
generating a hybrid prompt for the RAG model by combining the one or more topic summaries with retrieved data accessed by the RAG model in response to the prompt language.

2. The computer-implemented method of claim 1, further comprising:
receiving a new content item within the content management system;
determining a relationship between the new content item and the one or more topic summaries;
determining, utilizing the large language model, a relevance of the new content item in relation to the one or more topic summaries; and
based on the relevance of the new content item, updating the one or more topic summaries with content of the new content item.

3. The computer-implemented method of claim 1, further comprising:
generating, for the topic, the topic summary at a first length;
generating, for the topic, an additional topic summary at a second length different from the first length; and
storing the topic summary and the additional topic summary for the topic in the summary knowledge corpus.

4. The computer-implemented method of claim 1, further comprising:
generating an aggregate summary of one or more topic summaries; and
including the aggregate summary in the hybrid prompt.

5. The computer-implemented method of claim 1, further comprising:
identifying an entity associated with the topic of the topic summary;
generating a relationship summary defining a relationship between the entity and the topic of the topic summary; and
based on the relationship between the entity and the topic of the topic summary, including the relationship summary in the hybrid prompt.

6. The computer-implemented method of claim 1, further comprising:
pruning, within the content management system, at least one topic summary from the summary knowledge corpus by:
determining one or more summary generation factors associated with the topic summaries;
generating weights for the topic summaries based on the one or more summary generation factors;
comparing the weights of the topic summaries; and
removing a subset of the topic summaries that fall below a weight threshold from the summary knowledge corpus.

7. The computer-implemented method of claim 1, wherein determining the one or more topic summaries corresponding to the prompt language further comprises:
determining a relevance score for a topic summary by comparing an embedding of the topic summary to an embedding of the prompt language received from the client device; and
based on the relevance score, including the topic summary in the hybrid prompt.

8. A system comprising:
at least one processor; and
a non-transitory computer readable medium comprising instructions that, when executed by the at least one processor, cause the system to:
generate, utilizing a large language model at indexing time of a content item within a content management system, a topic summary for a topic within the content item;
add the topic summary to a summary knowledge corpus comprising topic summaries for a plurality of topics extracted from content items within the content management system, wherein the summary knowledge corpus further comprises relationship descriptions defining relationships among the plurality of topics;
determine, at runtime for a retrieval augmented generation (RAG) model in response to receiving prompt language from a client device, a relevance score for one or more topic summaries corresponding to the prompt language from the summary knowledge corpus; and
generate a hybrid prompt for the RAG model by combining, according to the relevance score, the one or more topic summaries with retrieved data accessed by the RAG model in response to the prompt language.

9. The system of claim 8, further comprising instructions that, when executed by the at least one processor, cause the system to:
receive a new content item within the content management system;
determine a relationship between the new content item and the one or more topic summaries;
determine , utilizing the large language model, a relevance of the new content item in relation to the one or more topic summaries; and
based on the relevance of the new content item, generate a new topic summary based on content of the new content item.

10. The system of claim 8, further comprising instructions that, when executed by the at least one processor, cause the system to generate the summary knowledge corpus by:
generating additional relationship descriptions defining relationships between the content items within the content management system and the topic summaries for the plurality of topics.

11. The system of claim 8, further comprising instructions that, when executed by the at least one processor, cause the system to:
monitor the prompt language received from one or more client devices associated with an entity within the content management system;
determine, based on the prompt language, a relevant topic for the entity; and
generate one or more topic summaries based on the relevant topic.

12. The system of claim 8, wherein determining the relevance score of one or more topic summaries further comprises comparing one or more embeddings of the one or more topic summaries to an embedding of the prompt language received from the client device.

13. The system of claim 8, further comprising instructions that, when executed by the at least one processor, cause the system to include references to one or more additional topics or relationships to the one or more additional topics in the topic summary.

14. The system of claim 8, further comprising instructions that, when executed by the at least one processor, cause the system to:
generate an embedding of the topic and an embedding of the prompt language received from the client device;
determine a distance between the embedding of the topic and the embedding of the prompt language by comparing the embedding of the topic with the embedding of the prompt language;
determine a length of the topic summary for the topic based on the distance between the embedding of the topic and the embedding of the prompt language; and
include the topic summary according to the determined length in the hybrid prompt.

15. A non-transitory computer readable medium comprising instructions that, when executed by at least one processor, cause the at least one processor to:
generate, utilizing a large language model at indexing time of a content item within a content management system, a topic summary for a topic within the content item;
add the topic summary to a summary knowledge corpus comprising topic summaries for a plurality of topics extracted from content items within the content management system;
determine, at runtime for a retrieval augmented generation (RAG) model in response to receiving prompt language from a client device, one or more topic summaries corresponding to the prompt language from the summary knowledge corpus; and
generate a hybrid prompt for the RAG model by combining the one or more topic summaries with retrieved data accessed by the RAG model in response to the prompt language.

16. The non-transitory computer readable medium of claim 15, further comprising instructions that, when executed by the at least one processor, cause the at least one processor to:
monitor, within the content management system, usage of the topic summaries for the plurality of topics within the summary knowledge corpus by an entity; and
remove, based on the usage of the topic summaries for the plurality of topics, a subset of the topic summaries for the plurality of topics.

17. The non-transitory computer readable medium of claim 15, further comprising instructions that, when executed by the at least one processor, cause the at least one processor to:
generate for the topic a first topic summary corresponding to a first length and a second topic summary corresponding to a second length;
receive additional prompt language from the client device; and
based on the additional prompt language, include the second topic summary in the hybrid prompt.

18. The non-transitory computer readable medium of claim 15, wherein the summary knowledge corpus further comprises one or more of relationship descriptions defining relationships among the plurality of topics, relationship summaries defining relationships between one or more entities and the plurality of topics, relationships between one or more content items and the plurality of topics, or relationships between one or more content items and the one or more entities.

19. The non-transitory computer readable medium of claim 15, further comprising instructions that, when executed by the at least one processor, cause the at least one processor to:
identify a change of one or more relationships among the plurality of topics; and
based on the change of the one or more relationships, update relationship descriptions defining the one or more relationships among the plurality of topics.

20. The non-transitory computer readable medium of claim 15, further comprising instructions that, when executed by the at least one processor, cause the at least one processor to:
determine to update the topic summaries for the plurality of topics by utilizing an additional large language model.
